(19) United States
(12) Patent Application Publication
(10) Pub. No.: US 2024/0103695 A1
(43) Pub. Date: Mar. 28, 2024

(54) Message Reply Method and Apparatus

(71) Applicant: Huawei Technologies Co., Ltd., Shenzhen (CN)

(72) Inventors: Zongwei Wang, Shenzhen (CN); Xiaojun Yu, Xi'an (CN)

(21) Appl. No.: 18/549,035

(22) PCT Filed: Feb. 22, 2022
(86) PCT No.: PCT/CN2022/077334

§ 371 Date: Sep. 5, 2023

(30) Foreign Application Priority Data
Mar. 5, 2021 (CN) 202110247186.0

(51) Int. Cl. G06F 3/0482; G06F 3/04845; G06F 3/0487; H04L 51/02

(52) U.S. Cl. CPC G06F 3/0482; G06F 3/04845; G06F 3/0487; H04L 51/02; G06F 2203/04803

(57) ABSTRACT

A message reply method includes displaying a first user interface including a message list, receiving a first trigger operation performed by a user on a first message box in the message list, where the first trigger operation is for triggering replying to a first contact corresponding to the first message box, obtaining, based on the first trigger operation, a reply message to the first contact when the first user interface is displayed, and sending the reply message to the first contact such that a user may implement a reply to a contact in a message list without opening a specific chat page.

### CROSS-REFERENCE TO RELATED APPLICATIONS

This application claims priority to Chinese Patent Application No. 202110247186.0, filed with the China National Intellectual Property Administration on Mar. 5, 2021 and entitled “MESSAGE REPLY METHOD AND APPARATUS”, which is incorporated herein by reference in its entirety.

### TECHNICAL FIELD

This application relates to the field of terminal technologies, and in particular, to a message reply method and apparatus.

### BACKGROUND

With the development of terminal technologies, a terminal has increasingly more functions. For example, a chat function is gradually added to the terminal based on a video playing function. A user can watch videos and chat with others on the terminal.

In a process of watching a video by the user, if a chat message is received, a common processing manner is: popping up a notification in the terminal, notifying to display the message, and based on user triggering, opening a chat interface of a contact corresponding to the message in the terminal, where the user may reply to the message in the chat interface.

However, the operation of replying to the message by the user is complex.

### SUMMARY

Embodiments of this application provide a message reply method and apparatus. A user may implement a quick reply to a contact in a message list without opening a specific chat page, to simplify operations.

According to a first aspect, an embodiment of this application provides a message reply method, including: displaying a first user interface including a message list; receiving a first trigger operation performed by a user on a first message box in the message list, where the first trigger operation is for triggering replying to a first contact corresponding to the first message box; obtaining, based on the first trigger operation, a reply message to the first contact when the first user interface is displayed; and sending the reply message to the first contact. In this way, in this embodiment of this application, the user may implement, in the first user interface, a quick reply to a contact corresponding to a message box by triggering the message box in the message list, without opening a specific chat interface of the contact, to simplify operations.

In a possible implementation, the reply message includes a voice message, a video message, or a text message. In this way, there are various manners of replying to a message, and different user requirements can be met.

In a possible implementation, the obtaining, based on the first trigger operation, a reply message to the first contact when the first user interface is displayed includes: obtaining, by an electronic device, a voice or a video based on the first trigger operation, to generate the reply message, where the voice or the video is collected by a remote control or the electronic device. In this way, the user may reply to a message in a voice or video reply manner.

In a possible implementation, the first user interface further includes video content being played, and the message list is displayed above the video content in a floating manner, or the message list and the video content are displayed in a split-screen manner. In this way, when a message of the contact is replied, a video in the electronic device can be normally played, and watching of the video by the user is not affected.

In a possible implementation, when the voice or the video is collected, a prompt indicating that the voice or the video is being collected is further displayed in the first user interface, where the prompt is located in the first message box. In this way, the electronic device may remind the user that a process of recording the voice or the video is being performed, and a video that is being watched by the user is not affected.

In a possible implementation, when the voice or the video is collected, a prompt indicating that the voice or the video is being collected is further displayed in the first user interface, where the prompt is located above the video content being played. In this way, the electronic device may remind the user that a process of recording the voice or the video is being performed.

In a possible implementation, the sending the reply message to the first contact includes: converting the collected voice or video into text; and sending a text message to the first contact.

In this embodiment of this application, the text may include at least one word, picture, and/or emoticon. For example, the voice may be converted into words, and the video may be converted into words and/or pictures. In this way, the electronic device may provide a plurality of optional reply manners for the user, so that the user can flexibly reply to a message.

In a possible implementation, after the reply message to the first contact is obtained, one or more of the following items are further displayed in the first user interface: a control for canceling sending of the reply message, a control for confirming sending of the reply message, and a control for prompting to convert the reply message into at least one word for sending. In this way, the user may perform different reply selections by using different trigger operations, thereby facilitating user operations.

In a possible implementation, the receiving a first trigger operation performed by a user on a first message box in the message list includes: receiving the first trigger operation performed through the remote control by the user on the first contact in the message list. In this way, this embodiment of this application may be applicable to a large screen scenario, and the user may trigger a quick reply on a large screen through the remote control.

It should be noted that, in this embodiment of this application, the first trigger operation may be an operation of triggering the first message box by the user in a touch or tap manner. The first trigger operation may alternatively be an operation of receiving, by the electronic device, an instruction of the remote control. For example, the user may send an instruction to the electronic device through the remote control. Specifically, the remote control may receive an operation like pressing a key of the user, and the remote control may send an instruction to the electronic device based on the operation of the user. In this case, the electronic device receives the first trigger operation.

In a possible implementation, before the displaying a first user interface including a message list, the method further includes: displaying a second user interface, where the second user interface includes a control for displaying the message list: and receiving a trigger operation on the control for displaying the message list. In this way, the large screen may display the message list based on triggering of the control by the user, so as to implement a quick reply in the message list.

In a possible implementation, the first user interface is an interface of a social application or an interface of a leftmost screen. In this way, the user may implement a quick reply in the social application or a leftmost screen in a device like a mobile phone or a tablet computer.

In a possible implementation, the message list includes a plurality of message boxes, where the plurality of message boxes are for respectively displaying one or more messages between different contacts and the user, and the contacts include a group or an individual. It should be noted that when a plurality of messages are displayed in a message box, more content can be displayed in the message box, so that the user can preview the messages.

In a possible implementation, the plurality of message boxes have a same size. In this way, display interfaces can be neat and unified. Alternatively, a size of each message box is scaled down or scaled up based on content in the message box. In this way, more content can be displayed in the message box, so that the user can preview the message. Alternatively, a thumbnail of a picture is displayed in each message box, so that the user can conveniently preview the picture in the message box.

In a possible implementation, the method further includes: scaling up the first message box when the first message box is selected, where the scaled-up first message box includes a plurality of chat messages or picture thumbnails of the first contact. In this way, the electronic device may display as much message content and picture previews as possible for the user in the message box, so that the user can preview the message content and picture previews.

In a possible implementation, the method further includes: receiving a second trigger operation performed by the user on a second message box in the message list, where the second trigger operation is for triggering opening a chat interface of a second contact corresponding to the second message box; and opening the chat interface corresponding to the second contact. In this way, the user may open a specific chart page of the contact to perform message replying.

According to a second aspect, an embodiment of this application provides an electronic device, including a processor, a memory, and a display, where the processor is configured to invoke the memory to perform a corresponding step; the display is configured to display a first user interface including a message list; the processor is configured to receive a first trigger operation performed by a user on a first message box in the message list, where the first trigger operation is for triggering replying to a first contact corresponding to the first message box; the processor is further configured to obtain, based on the first trigger operation, a reply message to the first contact when the first user interface is displayed; and the processor is further configured to send the reply message to the first contact.

In a possible implementation, the reply message includes a voice message, a video message, or a text message.

In a possible implementation, the electronic device further includes a microphone and a camera, and the processor is specifically configured to obtain a voice or a video based on the first trigger operation, to generate the reply message, where the voice or the video is collected by a remote control configured to control the electronic device, or the voice or the video is collected by the microphone and the camera.

In a possible implementation, the first user interface further includes video content being played, and the message list is displayed above the video content in a floating manner, or the message list and the video content are displayed in a split-screen manner.

In a possible implementation, the display is further configured to display, in the first user interface when the voice or the video is collected, a prompt indicating that the voice or the video is being collected, where the prompt is located in the first message box.

In a possible implementation, the display is further configured to display, in the first user interface when the voice or the video is collected, a prompt indicating that the voice or the video is being collected, where the prompt is located above the video content being played.

In a possible implementation, the processor is specifically configured to convert the collected voice or video into text; and the processor is further specifically configured to send a text message to the first contact.

In a possible implementation, the display is specifically configured to: after obtaining the reply message to the first contact, further display one or more of the following items in the first user interface: a control for canceling sending of the reply message, a control for confirming sending of the reply message, and a control for prompting to convert the reply message into at least one word for sending.

In a possible implementation, the processor is specifically configured to receive the first trigger operation performed through the remote control by the user on the first contact in the message list.

In a possible implementation, the display is further configured to display a second user interface, where the second user interface includes a control for displaying the message list; and the processor is further configured to receive a trigger operation on the control for displaying the message list.

In a possible implementation, the first user interface is an interface of a social application or an interface of a leftmost screen.

In a possible implementation, the message list includes a plurality of message boxes, where the plurality of message boxes are for respectively displaying one or more messages between different contacts and the user, and the contacts include a group or an individual.

In a possible implementation, the plurality of message boxes have a same size; a size of each message box is scaled down or scaled up based on content in the message box; or a thumbnail of a picture is displayed in each message box.

In a possible implementation, the processor is specifically configured to scale up the first message box when the first message box is selected, where the scaled-up first message box includes a plurality of chat messages or picture thumbnails of the first contact.

In a possible implementation, the processor is specifically configured to receive a second trigger operation performed by the user on a second message box in the message list, where the second trigger operation is for triggering opening a chat interface of a second contact corresponding to the second message box; and the processor is specifically configured to open the chat interface corresponding to the second contact.

According to a third aspect, an embodiment of this application provides an electronic device. The electronic device includes modules/units that perform the method according to the first aspect or any possible design of the first aspect. The modules/units may be implemented by hardware, or may be implemented by hardware executing corresponding software.

According to a fourth aspect, an embodiment of this application provides a chip. The chip is coupled to a memory in an electronic device, and is configured to invoke a computer program stored in the memory and perform the technical solution according to the first aspect and any possible design of the first aspect in embodiments of this application. In embodiments of this application, “coupling” means that two components are directly or indirectly combined with each other.

According to a fifth aspect, an embodiment of this application provides a computer-readable storage medium. The computer-readable storage medium includes a computer program, and when the computer program is run on an electronic device, the electronic device is enabled to perform the technical solution according to the first aspect and any possible design of the first aspect.

According to a sixth aspect, an embodiment of this application provides a computer program product. The computer program product includes instructions, and when the instructions are run on a computer, the computer is enabled to perform the technical solution according to the first aspect and any possible design of the first aspect.

According to a seventh aspect, an embodiment of this application provides a graphical user interface on an electronic device. The electronic device includes a display, one or more memories, and one or more processors. The one or more processors are configured to execute one or more computer programs stored in the one or more memories. The graphical user interface includes a graphical user interface displayed when the electronic device performs the technical solution according to the first aspect and any possible design of the first aspect.

For beneficial effects of the second aspect to the seventh aspect, refer to the beneficial effects of the first aspect. Details are not described again.

### BRIEF DESCRIPTION OF DRAWINGS

FIG. 1 is a schematic diagram of a scenario according to an embodiment of this application;

FIG. 2 is a schematic architectural diagram of a large-screen hardware system according to an embodiment of this application;

FIG. 3 is a schematic architectural diagram of a large-screen software system according to an embodiment of this application;

FIG. 4 is a schematic diagram of a message reply interface of a large screen in the conventional technology;

FIG. 5 is a schematic diagram of another message reply interface of a large screen in the conventional technology;

FIG. 6 is a schematic diagram of a quick reply interface according to an embodiment of this application;

FIG. 7 is a schematic interaction flowchart in a scenario according to an embodiment of this application;

FIG. 8A and FIG. 8B are schematic diagrams of a scenario of how to open a message list according to an embodiment of this application;

FIG. 9A to FIG. 9D are schematic interface diagrams of a displayable region of an interface according to an embodiment of this application;

FIG. 10 is a schematic interface diagram of a list message display form according to an embodiment of this application;

FIG. 11 is a schematic interface diagram of a list message display form according to an embodiment of this application;

FIG. 12 is a schematic interface diagram of a list message display form according to an embodiment of this application;

FIG. 13 is a schematic interface diagram of a list message display form according to an embodiment of this application;

FIG. 14A to FIG. 14D are schematic interface diagrams of quickly replying to a message through a voice according to an embodiment of this application;

FIG. 15A to FIG. 15D are schematic interface diagrams of quickly replying to a message through a voice according to an embodiment of this application;

FIG. 16A to FIG. 16D are schematic interface diagrams of quickly replying to a message through a voice according to an embodiment of this application;

FIG. 17A and FIG. 17B are schematic interface diagrams of quickly replying to a message through words according to an embodiment of this application;

FIG. 18A to FIG. 18C are schematic interface diagrams of quickly replying to a message through a video according to an embodiment of this application;

FIG. 19 is a schematic functional diagram of keys of a remote control according to an embodiment of this application;

FIG. 20 is a schematic functional diagram of keys of a remote control according to an embodiment of this application;

FIG. 21 is a schematic diagram of a scenario according to an embodiment of this application;

FIG. 22A and FIG. 22B are schematic diagrams of a mobile phone solution in the conventional technology;

FIG. 23A to FIG. 23C are schematic interface diagrams of a manner in which a mobile phone replies to a message according to an embodiment of this application;

FIG. 24A to FIG. 24D are schematic interface diagrams of a manner in which a mobile phone replies to a message according to an embodiment of this application;

FIG. 25A to FIG. 25D are schematic interface diagrams of a manner in which a mobile phone replies to a message according to an embodiment of this application;

FIG. 26A to FIG. 26C are schematic interface diagrams of a manner in which a mobile phone replies to a message according to an embodiment of this application;

FIG. 27A to FIG. 27C are schematic interface diagrams of a manner in which a mobile phone replies to a message according to an embodiment of this application;

FIG. 28A and FIG. 28B are schematic interface diagrams of a manner in which a mobile phone replies to a message according to an embodiment of this application;

FIG. 29 is a schematic diagram of a structure of a message reply apparatus according to an embodiment of this application; and

FIG. 30 is a schematic diagram of a hardware structure of a message reply apparatus according to an embodiment of this application.

### DESCRIPTION OF EMBODIMENTS

To clearly describe technical solutions in embodiments of this application, terms such as “first” and “second” are used in embodiments of this application to distinguish between same items or similar items that provide basically same functions or purposes. For example, an interface of a first target function and an interface of a second target function are used for distinguishing between different response interfaces, and a sequence thereof is not limited. A person skilled in the art may understand that the terms such as “first” and “second” do not limit a quantity or an execution sequence, and the terms such as “first” and “second” do not indicate a definite difference.

It should be noted that, in this application, words such as “example” or “for example” are used for representing giving an example, an illustration, or a description. Any embodiment or design scheme described as an “example” or “for example” in this application should not be explained as being more preferred or having more advantages than another embodiment or design scheme. Exactly, use of the words such as “example” or “for example” is intended to present a relative concept in a specific manner.

It should be noted that “when . . . ” in embodiments of this application may be an instant when a case occurs, or may be a period of time after a case occurs. This is not specifically limited in embodiments of this application.

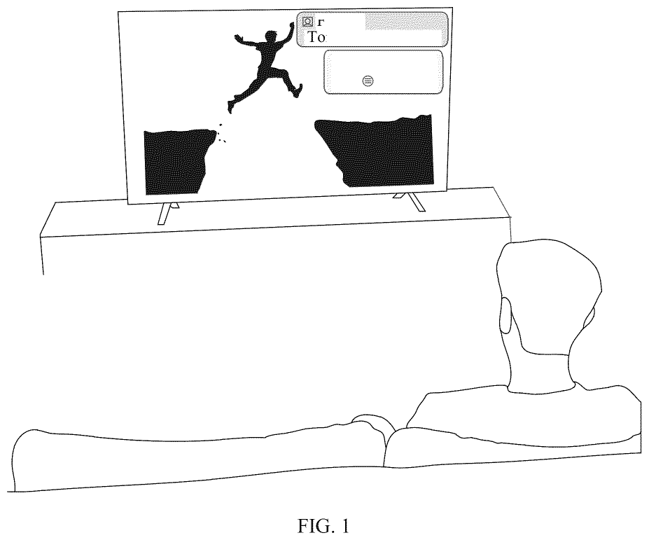

A message reply method and apparatus provided in embodiments of this application may be applied to an electronic device having a display function. The electronic device may be configured to watch a video, check a message, and the like. For example, FIG. 1 is a schematic diagram of a scenario according to an embodiment of this application. As shown in FIG. 1, when watching a video on a large screen, a user may receive a chat message from a social application.

The electronic device may include a large screen (or referred to as a smart screen), a mobile phone, a tablet computer, a smart watch, a smart band, a smart headset, smart glasses, or another terminal device having a display. This is not limited in embodiments of this application.

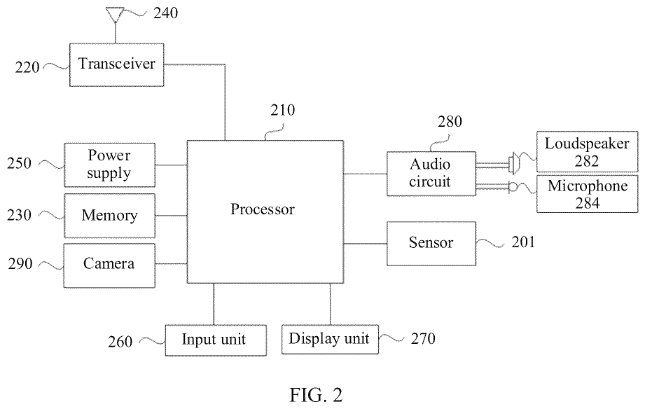

For example, the electronic device is a large screen. FIG. 2 is a schematic architectural diagram of a large-screen hardware system according to an embodiment of this application.

As shown in FIG. 2, the electronic device includes a processor 210, a transceiver 220, and a display unit 270. The display unit 270 may include a display.

Optionally, the electronic device may further include a memory 230, The processor 210, the transceiver 220, and the memory 230 may communicate with each other by using an internal connection path, to transfer a control signal and/or a data signal. The memory 230 is configured to store a computer program. The processor 210 is configured to invoke the computer program from the memory 230 and run the computer program.

Optionally, the electronic device may further include an antenna 240, configured to send a wireless signal outputted by the transceiver 220.

The processor 210 and the memory 230 may be integrated into one processing apparatus, or more commonly, components independent of each other. The processor 210 is configured to execute program code stored in the memory 230 to implement the foregoing functions. During specific implementation, the memory 230 may alternatively be integrated into the processor 210, or may be independent of the processor 210.

In addition, to make functions of the electronic device more perfect, the electronic device may further include one or more of an input unit 260, an audio circuit 280, a camera 290, and a sensor 201. The audio circuit may further include a loudspeaker 282 and a microphone 284.

Optionally, the electronic device may further include a power supply 250, configured to supply power to various components or circuits in a terminal device.

It may be understood that operations and/or functions of the modules in the electronic device shown in FIG. 2 are respectively for implementing corresponding procedures in the following method embodiments. For details, refer to descriptions in the following method embodiments. To avoid repetition, detailed descriptions are properly omitted herein.

It may be understood that the processor 210 in the electronic device shown in FIG. 2 may include one or more processing units. For example, the processor 210 may include an application processor (application processor, AP), a modem processor, a graphics processing unit (graphics processing unit. GPU), an image signal processor (image signal processor, ISP), a controller, a video codec, a digital signal processor (digital signal processor, DSP), a baseband processor, and/or a neural-network processing unit (neural-network processing unit, NPU). Different processing units may be independent components, or may be integrated into one or more processors.

A memory may be further disposed in the processor 210, and is configured to store instructions and data. In some embodiments, the memory in the processor 210 is a cache. The memory may store instructions or data that is just used or cyclically used by the processor 210. If the processor 210 needs to use the instructions or the data again, the processor may directly invoke the instructions or the data from the memory. This avoids repeated access and reduces a waiting time of the processor 210, thereby improving system efficiency.

In some embodiments, the processor 210 may include one or more interfaces. The interface may include an inter-integrated circuit (inter-integrated circuit. I2C) interface, an inter-integrated circuit sound (inter-integrated circuit sound, I2S) interface, a pulse code modulation (pulse code modulation, PCM) interface, a universal asynchronous receiver/transmitter (universal asynchronous receiver/transmitter, DART) interface, a mobile industry processor interface (mobile industry processor interface, MTN), a general-purpose input/output (general-purpose input/output, GPIO) interface, a subscriber identity module (subscriber identity module, SIM) interface, and/or a universal serial bus (universal serial bus, USB) interface.

The I2C interface is a two-way synchronous serial bus, and includes a serial data line (serial data line, SDA) and a serial clock line (serial clock line, SCL). In some embodiments, the processor 210 may include a plurality of groups of I2C buses. The processor 210 may be separately coupled to a touch sensor 180K, a charger, a flash, and the camera 290 by using different I2C bus interfaces. For example, the processor 210 may be coupled to the touch sensor 180K by using the I2C interface, so that the processor 210 communicates with the touch sensor 180K by using the I2C bus interface, to implement a touch function of the electronic device.

The I2S interface may be used for audio communication. In some embodiments, the processor 210 may include a plurality of groups of I2S buses. The processor 210 may be coupled to the audio circuit 280 through an I2S bus, to implement communication between the processor 210 and the audio circuit 280. In some embodiments, the audio circuit 280 may transmit an audio signal to the transceiver 220 through the I2S interface, to implement a function of answering a voice call by using a Bluetooth headset.

The PCM interface may also be used for audio communication, to sample, quantize, and encode an analog signal. In some embodiments, the audio circuit 280 may be coupled to the transceiver 220 through a PCM bus interface. In some embodiments, the audio circuit 280 may alternatively transmit an audio signal to the transceiver 220 by using the PCM interface, to implement a function of answering a voice call by using a Bluetooth headset. Both the I2S interface and the PCM interface may be used for audio communication.

The UART interface is a universal serial data bus, and is used for asynchronous communication. The bus may be a two-way communication bus. The bus converts to-be-transmitted data between serial communication and parallel communication. In some embodiments, the LIARS interface is usually configured to connect the processor 210 to the transceiver 220. For example, the processor 210 communicates with a Bluetooth module in the transceiver 220 by using the UART interface, to implement a Bluetooth function. In some embodiments, the audio circuit 280 may transmit an audio signal to the transceiver 220 by using the UART interface, to implement a function of playing music by using a Bluetooth headset.

The MIPI interface may be configured to connect the processor 210 to a peripheral component like the display unit 270 or the camera 290. The MIPI interface includes a camera serial interface (camera serial interface, CSI) and a display serial interface (display serial interface, DSI), In some embodiments, the processor 210 communicates with the camera 290 by using the CSI interface, to implement a shooting function of the electronic device. The processor 210 communicates with the display unit 270 by using the DSI interface, to implement a display function of the electronic device.

The GPIO interface may be configured by using software. The GPIO interface may be configured as a control signal or a data signal. In some embodiments, the GPIO interface may be configured to connect the processor 210 to the camera 290, the display unit 270, the transceiver 220, the audio circuit 280, and the sensor 201. The GPIO interface may alternatively be configured as an I2C interface, an 12S interface, a DART interface, or an MIPI interface.

It may be understood that, an interface connection relationship between the modules shown in this embodiment of this application is merely an example for description, and does not constitute a limitation on a structure of the electronic device. In some other embodiments of this application, the electronic device may alternatively use an interface connection manner different from that in the foregoing embodiment, or a combination of a plurality of interface connection manners.

It may be understood that the power supply 250 shown in FIG. 2 is configured to supply power to the processor 210, the memory 230, the display unit 270, the camera 290, the input unit 260, and the transceiver 220.

The antenna 240 is configured to transmit and receive an electromagnetic wave signal. Each antenna in the electronic device may be configured to cover one or more communication frequency bands. Different antennas may also be multiplexed, to improve utilization of the antennas. For example, the antenna 240 may be multiplexed as a diversity antenna in a wireless local area network. In some other embodiments, the antenna may be used in combination with a tuning switch.

The transceiver 220 may provide a solution to wireless communication that is applied to the electronic device and that includes a wireless local area network (wireless local area network, WLAN) (like a wireless fidelity (wireless fidelity, Wi-Fi) network), Bluetooth (Bluetooth, BT), a global navigation satellite system (global navigation satellite system, GNSS), frequency modulation (frequency modulation, FM), a near field communication (near field communication, NFC) technology, and an infrared (infrared, IR) technology. The transceiver 220 may be one or more components integrating at least one communication processing module. The transceiver 220 receives an electromagnetic wave through the antenna 240, performs frequency modulation and filtering processing on an electromagnetic wave signal, and sends a processed signal to the processor 210. The transceiver 220 may further receive a to-be-sent signal from the processor 210, perform frequency modulation and amplification on the signal, and convert the signal into an electromagnetic wave for radiation by using the antenna 240.

In some embodiments, the antenna 240 of the electronic device is coupled to the transceiver 220, so that the electronic device may communicate with a network and another device by using a wireless communication technology. The wireless communication technology may include a global system for mobile communications (global system for mobile communications, GSM), a general packet radio service (general packet radio service, GPRS), code division multiple access (code division multiple access. CDMA), wideband code division multiple access (wideband code division multiple access, WCDMA), time-division code division multiple access (time-division code division multiple access, TD-SCDMA), long term evolution (long term evolution, LTE), BT, a GNSS, a MILAN, NFC, FM, and/or an IR technology. The GNSS may include a global positioning system (global positioning system, GPS), a global navigation satellite system (global navigation satellite system, GLONASS), a Beidou navigation satellite system (Beidou navigation satellite system, BDS), a quasi-zenith satellite system (quasi-zenith satellite system, QZSS), and/or a satellite based augmentation system (satellite based augmentation system, SBAS).

The electronic device implements a display function through the GPU, the display unit 270, and the application processor. The GPU is a microprocessor for image processing, and is connected to the display unit 270 and the application processor. The GPU is configured to perform mathematical and geometric calculation, and is configured to render an image. The processor 210 may include one or more GPUs that execute program instructions to generate or change display information.

The display unit 270 is configured to display an image or a video. The display unit 270 includes a display panel. The display panel may be a liquid crystal display (liquid crystal display, LCD), an organic light-emitting diode (organic light-emitting diode, OLED), an active-matrix organic light-emitting diode or an active-matrix organic light-emitting diode (active-matrix organic light-emitting diode, AMOLED), a flex light-emitting diode (flex light-emitting diode, FLED), a Miniled, a MicroLed, a Micro-oLed, or a quantum dot light-emitting diode (quantum dot light-emitting diode, OLED). In some embodiments, the electronic device may include one or N display units 270, where N is a positive integer greater than 1.

The electronic device may implement a shooting function by using the ISP, the camera 290, the video codec, the GPU, the display unit 270, and the application processor.

The ISP is configured to process data fed back by the camera 290. For example, during video recording, a camera is turned on, light is transferred to a camera photosensitive element by using a lens, an optical signal is converted into an electrical signal, and the camera photosensitive element transfers the electrical signal to the TSP for processing, to convert the electrical signal into an image visible to a naked eye. The ISP may further perform algorithm optimization on noise, brightness, and complexion of the image. The ISP may further optimize parameters such as exposure and color temperature of a shooting scene. In some embodiments, the ISP may be disposed in the camera 290.

The camera 290 is configured to capture a static image or a video. An optical image of an object is generated through the lens and is projected onto the photosensitive element. The photosensitive element may be a charge-coupled device (charge-coupled device, CCD) or a complementary metal-oxide-semiconductor (complementary metal-oxide-semiconductor, CMOS) optoelectronic transistor. The photosensitive element converts an optical signal into an electrical signal, and then transfers the electrical signal to the ISP for converting the electrical signal into a digital image signal. The ISP outputs the digital image signal to the DSP for processing. The DSP converts the digital image signal into an image signal in a standard format like RGB or WV In some embodiments, the electronic device may include one or N cameras 290, where N is a positive integer greater than 1.

The digital signal processor is configured to process a digital signal, and may further process another digital signal in addition to the digital image signal. For example, when the electronic device selects a frequency, the digital signal processor is configured to perform Fourier transformation on frequency energy.

The video codec is configured to compress or decompress a digital video. The electronic device may support one or more video codecs. In this way, the electronic device may play or record videos in a plurality of encoding formats, for example, moving picture experts group (moving picture experts group, MPEG) 1, MPEG2, MPEG3, and MPEG4.

The NPU is a neural-network (neural-network, NN) computing processor. The NPU quickly processes input information by referring to a biological neural network structure, for example, by referring to a mode of transfer between human brain neurons, and may further continuously perform self-learning. Intelligent cognition of the electronic device, for example, image recognition, facial recognition, voice recognition, text understanding, or the like may be implemented by using the NPU.

The memory 230 may be configured to store computer executable program code, where the executable program code includes instructions. The memory 230 may include a program storage region and a data storage region. The program storage region may store an operating system, an application program required by at least one function (for example, a sound playing function or an image playing function), and the like. The data storage region may store data (such as audio data and an address book) created when the electronic device is used. In addition, the memory 230 may include a high-speed random access memory, and may further include a non-volatile memory, for example, at least one magnetic disk storage device, a flash memory device, or a universal flash storage (universal flash storage, UFS). The processor 210 runs the instructions stored in the memory 230 and/or the instructions stored in the memory disposed in the processor, to execute various functional applications and data processing of the electronic device.

The electronic device may implement an audio function by using the audio circuit 280, the loudspeaker 282, the microphone 284, and the application processor, for example, music playing and recording.

The audio circuit 280 is configured to convert digital audio information into an analog audio signal for output, and is also configured to convert an analog audio input into a digital audio signal. The audio circuit 280 may be further configured to encode and decode an audio signal. In some embodiments, the audio circuit 280 may be disposed in the processor 210, or some functional modules in the audio circuit 280 are disposed in the processor 210.

The loudspeaker 282, also referred to as a “horn”, is configured to convert an audio electrical signal into a sound signal. The electronic device may listen to music or answer a hands-free call by using the loudspeaker 282.

The microphone 284, also referred to as a “mouthpiece” or a “megaphone”, is configured to convert a sound signal into an electrical signal. When making a call or sending voice information, a user may make a sound near the microphone 284, to input a sound signal to the microphone 284. At least one microphone 284 may be disposed in the electronic device. In some other embodiments, two microphones 284 may be disposed in the electronic device, to collect a sound signal and further implement a noise reduction function. In some other embodiments, three, four, or more microphones 284 may alternatively be disposed in the electronic device, to collect a sound signal, implement noise reduction, identify a sound source, implement a directional recording function, and the like.

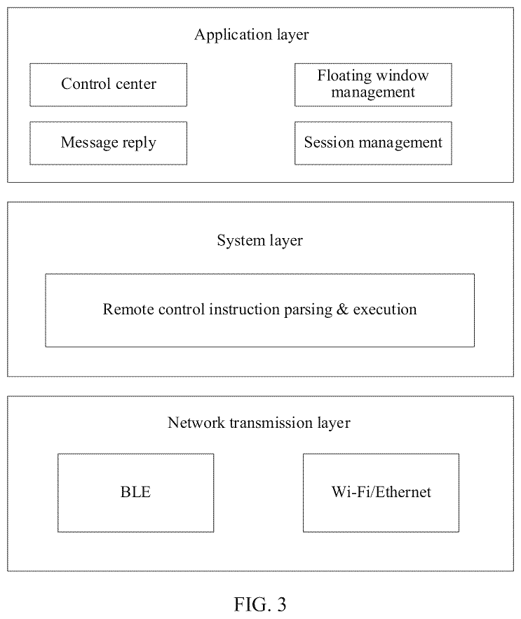

For example, FIG. 3 is a schematic architectural diagram of a large-screen software system according to an embodiment of this application.

As shown in FIG. 3, the layered architecture divides software into several layers, and each layer has a clear role and task. The layers communicate with each other through a software interface. In some embodiments, the large-screen software system is divided into three layers: an application layer, a system layer, and a network transmission layer from top to bottom.

The application layer may include a control center, floating window management, message reply, and session management.

The floating window management is for managing content related to popping up or hiding of a floating window. For example, the floating window management may be for managing transparency of the floating window; a position of a display region in which the floating window is located, and content displayed in the floating window.

The message reply is for providing a message reply function. For example, the message reply may provide the system with a plurality of message reply functions such as voice reply, word reply, and video reply.

The session management is for managing session content. For example, the session management may be for managing a quantity of message boxes in a message list of an application program and content in each message box.

The control center is a core part of the software system, and may open of a next layer or return to an upper layer through instructions. For example, the control center may be configured to control popping up of the floating window based on content in the session management, and display specific content in the session management in the floating window. The control center may further implement message reply based on a reply instruction and by controlling the message reply. Alternatively, it may be understood that the control center has a “central” function.

It may be understood that the application layer may further include other content and implement another function. This is not specifically limited in this embodiment of this application.

The system layer may include a remote control instruction parsing and execution function. For example, a remote control instruction is received, and the remote control instruction may be parsed at the system layer, and the parsed instruction is sent to the control center at the application layer, so as to implement corresponding control.

The network transmission layer is used for large-screen communication and data transmission. For example, the network transmission layer may include a Bluetooth low energy (Bluetooth low energy, BLE) function, a wireless fidelity (wireless fidelity, Wi-Fi) or Ethernet (Ethernet) function.

A BLE module may be configured to communicate with a remote control, for example, receive a control instruction of the remote control.

A Wi-Fi or Ethernet module is configured to receive a message and send a message.

In the conventional technology, in a process in which the user watches a video on a large screen, if the user receives a chat message from a social application, there may be two reply manners.

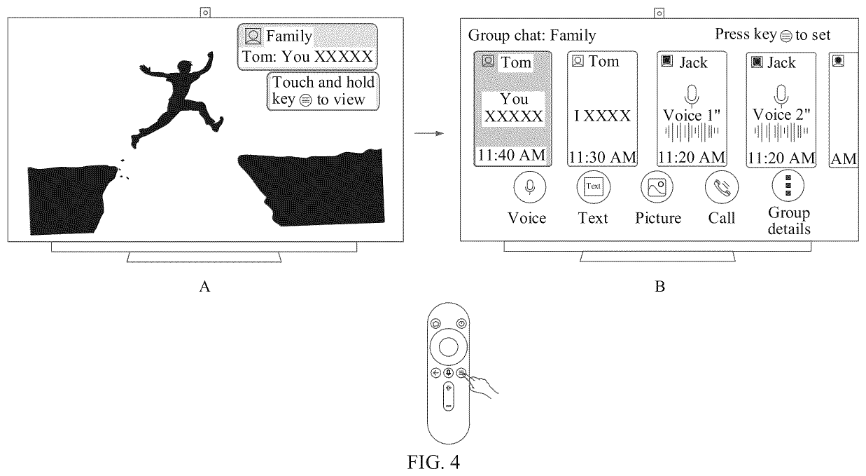

For example, FIG. 4 is a schematic diagram of a message reply interface in the conventional technology.

As shown in A in FIG. 4, when the user receives information “you XXX” from Tom in a “Family” message group, a notification may pop up on the large screen, and the notification displays the message of Tom in the “Family” message group. The large screen may further display prompt information, where the prompt information is for prompting the user to open a chat page of the “Family” message group by touching and holding a “menu key” on the remote control.

If the user opens the chat page of the “Family” message group by using the “menu key” on the remote control, as shown in B in FIG. 4, information content of each contact in the “Family” group and a reply manner “Voice”, “Text”, “Picture”, “Call”, or “Group details” that can be selected by the user may be displayed on the large screen. The user may select “Voice”, “Text”, “Picture”, “Call”, or “Group details” by using the remote control to reply.

However, in this manner, when the user receives information on the large screen, the user opens a specific chat page, for example, the chat page of the “Family” message group shown in FIG. 4. If the user completes replying in the chat page of the “Family” message group and wants to reply to another contact Jack, the user needs to exit the chat page of the “Family” message group and then open a chat page of the contact Jack, which is complex to operate. In addition, when the user opens the chat page of the “Family” message group, the video that the user is watching cannot be played continuously, affecting video watching by the user.

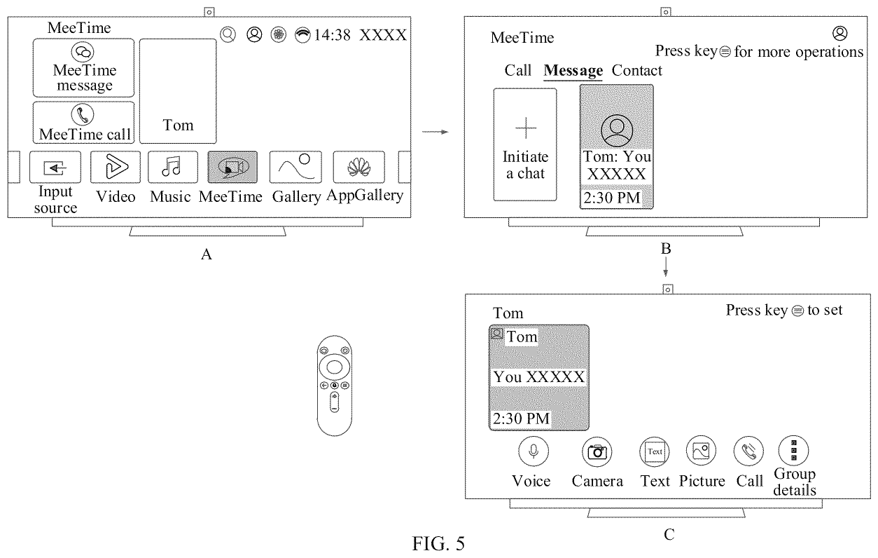

FIG. 5 is a schematic diagram of another message reply interface in the conventional technology.

The user may exit a current video application by using the remote control, and open an interface of a “MeeTime” application shown in A in FIG. 5. Further, the user may select “MeeTime” by using the remote control, open a message page shown in Bin FIG. 5, and open a specific chat page shown in C in FIG. 5 by selecting a contact to which the user wants to reply, so that the user may select “Voice”, “Text”, “Picture”, “Call”, or “Group details” by using the remote control to reply.

However, in this manner, when receiving information on the large screen, the user needs to exit the video application, enter a social application, and open a specific chat page in the social application to reply, which is complex to operate. In addition, the video that the user is watching cannot be played, affecting video watching by the user.

In summary, in the conventional technology. When the user watches a video on the large screen, if the user replies to a message of a social application, many operations are required, which is complex to operate, and video watching is disturbed.

Based on this, an embodiment of this application provides a message reply method. When watching a video in an electronic device, if a user receives a chat message of a social application, the user may trigger opening an interface including a message list. In the message list, the user may trigger a quick reply to any contact without opening a specific chat page. The quick reply may include a voice reply, a word reply, or a video reply. This is not specifically limited in this embodiment of this application.

It should be noted that the “contact” in this embodiment of this application may include an individual contact or may include a group chat. This is not limited in embodiments of this application.

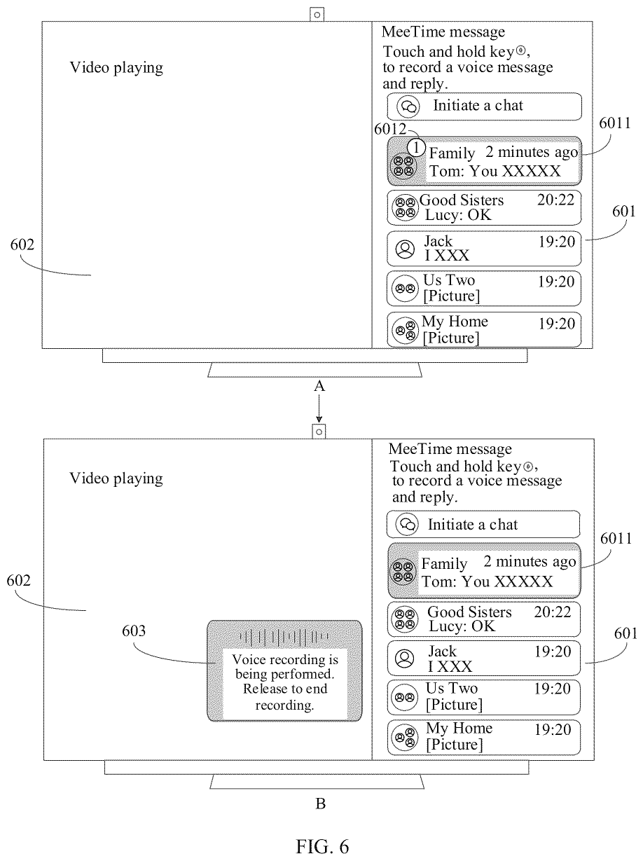

For example, FIG. 6 is a schematic diagram of a quick reply interface according to an embodiment of this application.

When the user receives information “you XXX” from Tom in a “Family” message group in FIG. 1, the user may trigger opening a display interface shown in FIG. 6A, where the display interface includes a message list region 601 and a video playing region 602. The message list region 601 may include a message list. As shown in FIG. 6A, the message list may include: the “Family” message group, a “Good Sisters” message group, a contact Jack, and the like.

It may be understood that the “Family” message group including an unread message may be displayed on top of the message list, and an identifier 6012 indicating a quantity of unread messages may be further displayed near an avatar of the “Family” message group including the unread message. Certainly, if the user presets a contact displayed on top of the message list, a top display position in the message list may be the contact preset by the user, and contacts including unread messages may be sequentially displayed under the top contact based on a receiving time. Display of the message list is not limited in embodiments of this application.

The user may select the “Family” message group by using the remote control, to reply to the “Family” message group without opening a specific chat page of the “Family” message group. For example, the user may touch and hold the “Family” message group by using the remote control, to trigger a voice reply to the “Family” message group, and open the user interface shown in FIG. 6B. As shown in FIG. 6B, the user interface may further include content 603 prompting that recording is being performed. After recording, the user may release the remote control, to send a reply voice to the “Family” message group.

It should be noted that the user may alternatively reply by converting a voice into words, through words, or through a video. This is described in detail in subsequent embodiments, and is not specifically limited in this embodiment of this application.

It may be understood that, in the process of replying to a message by the user, a video in the video playing region 602 may be normally played, and video watching by the user is not affected.

In a possible implementation, the message list region 601 may be floated as, for example, a transparent display box on an upper layer of the video playing region 602, and the video playing region 602 may extend to the entire large screen. Alternatively, the message list region 601 and the video playing region 602 may be displayed in a split-screen manner, and the video playing region 602 and the message list region 601 each occupy a part of the large screen. A specific display manner is not limited in embodiments of this application.

In conclusion, in this embodiment of this application, when a user watches a video in an electronic device, if the user replies to a message of a social application, the user may trigger opening an interface including a message list. In the message list, the user may trigger a quick reply to any contact without opening a specific chat page. Further, when the user replies to the information, the video may be played continuously without affecting video watching by the user.

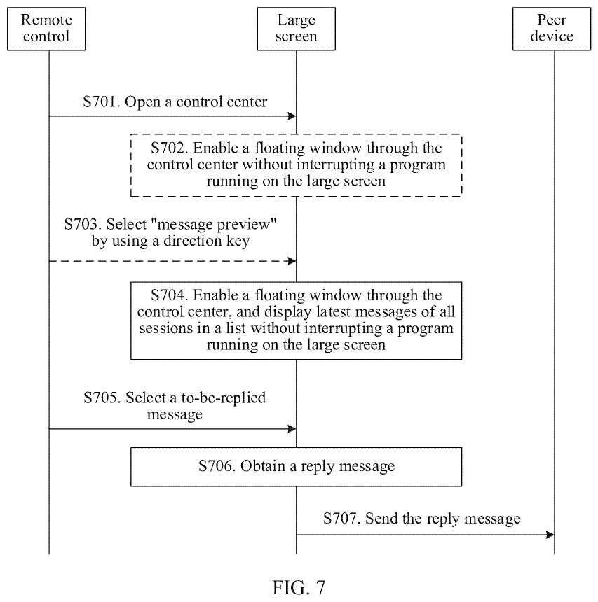

Specifically, an example in which the electronic device is a large screen is used. FIG. 7 is a schematic interaction flowchart in a large screen scenario according to an embodiment of this application. The message reply method may include:

S701. The large screen opens a control center based on a user operation.

For example, when a user watches a video in the electronic device, if information from a social application is received, the user performs an operation of triggering a remote control key, to send a first remote control instruction to the large screen, and the large screen opens the control center based on the first remote control instruction.

S702. The large screen enables a floating window by using the control center.

In this embodiment of this application, the floating window may be a window that is floating in a translucent state in the large screen, and related content may be displayed in the large screen by layers.

For example, after receiving the first remote control instruction in the control center, the large screen may control, based on the control center, floating window management to pop up a floating window on the screen. The floating window may display “message preview” for triggering opening a message list. Subsequently, the user may move a focus in the floating window to the “message preview” to trigger displaying the message list.

Further, when the floating window is displayed on the large screen, an application program that is running on the large screen may not be interrupted. For example, a video may be continuously played on the large screen, so that watching experience of the user is not affected.

S703. The user selects “message preview” by using direction keys of the remote control.

Adaptively, the large screen may also receive a second remote control instruction from the remote control, where the second remote control instruction instructs to display the message list.

In this embodiment of this application, the direction keys are also referred to as functional keys, and may include up and down keys, and left and right keys.

For example, the user may move the focus by using, the direction keys of the remote control, move the focus to “message preview”, and select the “message preview”.

It should be noted that the “message preview” is merely an example for description. In an actual application, a button configured to trigger opening the message list may also be marked as a “MeeTime message”.

S704. The large screen enables a message floating window by using the control center, and displays a message list, where the message list includes a latest message of at least one session.

In this embodiment of this application, the message list may be a list that can display a plurality of contacts. In the message list, a latest message received from each contact may be further displayed below each contact. Certainly, in an actual application, one or more contacts may be displayed in the message list based on an actual situation. However, the message list itself has a capability of displaying a plurality of contacts. A specific display situation of the message list is not limited in embodiments of this application.

It should be noted that the message list in this embodiment of this application is different from a message prompt box and a specific chat page. For example, the message prompt box may be a message box that is popped up on a screen for prompting a message of a specific contact, and the specific chat page corresponds to a recent chat page of a contact. The message list may display a list of one or more contacts, and may further display a preview of a latest message received from the one or more contacts instead of a specific chat page.

In this embodiment of this application, a session may be a chat event. For example, if the contact is a group, a chat event in the group (for example, chat content generated by one or more contacts in the group) may be referred to as a session. If the contact is an individual, a chat event of the individual (for example, one or more chat records generated by the contact) may be referred to as a session.

Alternatively, it may be understood that, the message list displays a contact corresponding to at least one session and a latest message received from the contact, and tapping the contact corresponding to the session or the latest message received from the contact may trigger to reply to the contact, or open an application interface corresponding to the session.

For example, the large screen may display the message list in a form of a translucent floating window in a running program. The message list displays a plurality of contacts and latest messages of the plurality of contacts. For details, refer to the display manner and record in FIG. 6, and details are not described herein again.

Further, when the message list is displayed on the large screen, an application program that is running on the large screen may not be interrupted. For example, a video may be continuously played on the large screen, so that watching experience of the user is not affected.

S705. The user selects, by using the remote control, a message that needs to be replied in the message list.

For example, the user may select a message box that needs to be replied in the message list by moving the focus by using the remote control, and press a message reply key to reply. For example, after selecting the message box that needs to be replied, the user may reply by touching and holding a “voice reply” key on the remote control, or may reply by pressing a “voice reply” key on the remote control. A specific reply manner is described in detail in subsequent embodiments, and is not limited herein.

S706. The large screen obtains a reply message.

For example, the user may record a voice or a video by using the large screen or the remote control, and the large screen may obtain a reply message in a voice format or a video format. Alternatively, the user may enter at least one word on the large screen, and the large screen may obtain a reply message in a word format.

A specific interface or user operation through which the large screen obtains the reply message is described in detail in subsequent embodiments. This is not specifically limited in this embodiment of this application.

S707. The large screen sends the reply message to a peer device.

The peer device may be a device that sends a chat message to the large screen, or may be understood as a device of a contact corresponding to the reply message.

For example, after obtaining the reply message, the large screen may send the reply message to the peer device based on user triggering or by itself. A specific interface or user operation for sending the reply message to the peer device by the large screen is described in detail in subsequent embodiments. This is not specifically limited in this embodiment of this application.

It should be noted that, in this embodiment of this application, S702 and S703 are optional steps. For example, the user may open the control center based on the remote control, and after enabling the floating window by using the control center, the user may open an interface including a display list. To be specific, S702 and S703 may be removed, and the user opens the interface shown in FIG. 6A from the user interface shown in FIG. 1.

In conclusion, in this embodiment of this application, when a user watches a video in an electronic device, if the user receives information of a social application, the user may trigger opening an interface including a message list. In the message list, the user may trigger a quick reply to any contact without opening a specific chat page. Further, when the user replies to the information, the video may be played continuously without affecting video watching by the user.

To describe embodiments of this application more clearly, the following describes embodiments of this application with reference to the schematic architectural diagram shown in FIG. 3, the user interface diagram in FIG. 6, and the flowchart in FIG. 7.

The network transmission layer receives information sent by another device to the large screen, and transmits the information to the session management. The session management reports specific message content to the control center based on the received information. The remote control sends an instruction to the large screen based on a user operation. The large screen receives the instruction based on the network transmission layer and sends the instruction to the system layer. After parsing the instruction, the system layer sends the parsed instruction to the control center. The control center indicates, based on the instruction, the floating window management to pop up a floating box, and displays a specific message list in the floating window with reference to the message content in the session management.

Further, the remote control generates a reply instruction based on a reply operation performed by the user on a message in the message list. The large screen receives the reply instruction based on the network transmission layer, and sends the reply instruction to the system layer. After parsing the reply instruction, the system layer sends the parsed reply instruction to the control center. The control center delivers the reply instruction to a message reply functional module. The message reply module manages subsequent processes such as obtaining reply content and replying to a message.

Corresponding to FIG. 6, the floating window popped up by the large screen in FIG. 6A is managed by a floating window management module, and specific message content displayed in the floating window is managed by a session management module. After replying is triggered, a recording box 603 popped up in FIG. 6B and an interface for message replying are managed by the message reply module.

In conclusion, in this embodiment of this application, when a user watches a video on a large screen, if the user receives a message of a social application, the user can implement a quick reply to the message. The quick reply may be specifically related to the following three phases: a phase of opening a message list, a phase of displaying the message list, and a phase of performing a quick reply based on the message list.

In subsequent embodiments, the three phases are separately described with reference to schematic interface diagrams.

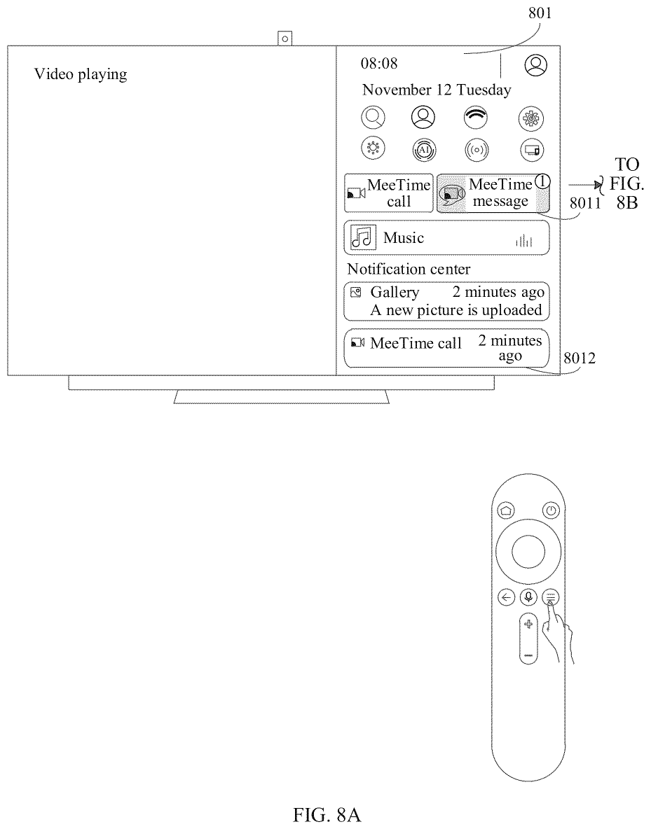

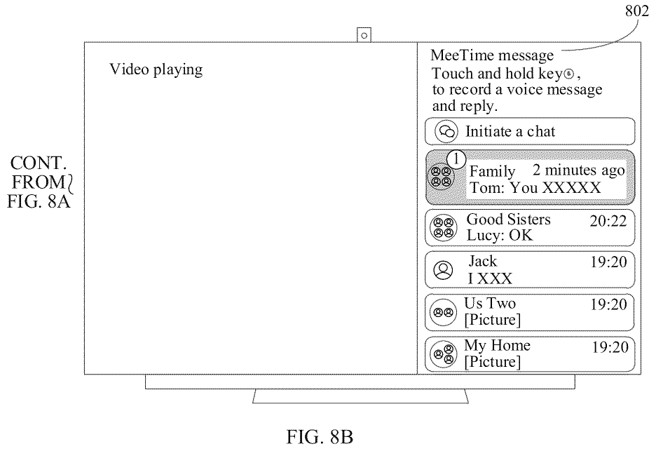

In the phase of opening a message list, for example, FIG. 8A and FIG. 8B are schematic diagrams of a scenario of how to open a message list according to an embodiment of this application.

Corresponding to S701 to S704 in FIG. 7, the user may open the control center by touching and holding the “menu key” on the remote control, and a floating box 801 shown in FIG. 8A may be displayed on the large screen. The floating box 801 may display a “MeeTime message” button 8011 for triggering displaying a message list. Further, the user may move a focus to the “MeeTime message” button by using the remote control, and select the “MeeTime message” button by using the remote control, to open an interface shown in FIG. 8B, where the message list is displayed in a floating box 802.

It may be understood that, if the large screen supports a touch function, the user may also select the “MeeTime message” button by touching and tapping. A specific manner of selecting the “MeeTime message” button is not limited in embodiments of this application. Optionally, the interface shown in FIG. 8A may further include a “MeeTime call” button 8012 for opening a contact chat interface. The user may also trigger the “MeeTime call” button 8012 by using the remote control to select a focus or by touching and tapping, to open the user interface shown in FIG. 4B, thereby quickly opening the chat interface.

It should be noted that, corresponding to the description of the embodiment in FIG. 7, the user may alternatively control, by using the remote control, the large screen to directly switch from the interface shown in FIG. 1 to the interface shown in FIG. 8B without opening the interface shown in FIG. 8A. In this way, operations of opening a message list display interface by the user may be simplified with more convenience.

In the phase of displaying the message list, a position of the message list in the large screen and a specific display manner of message content in the message list are not limited.

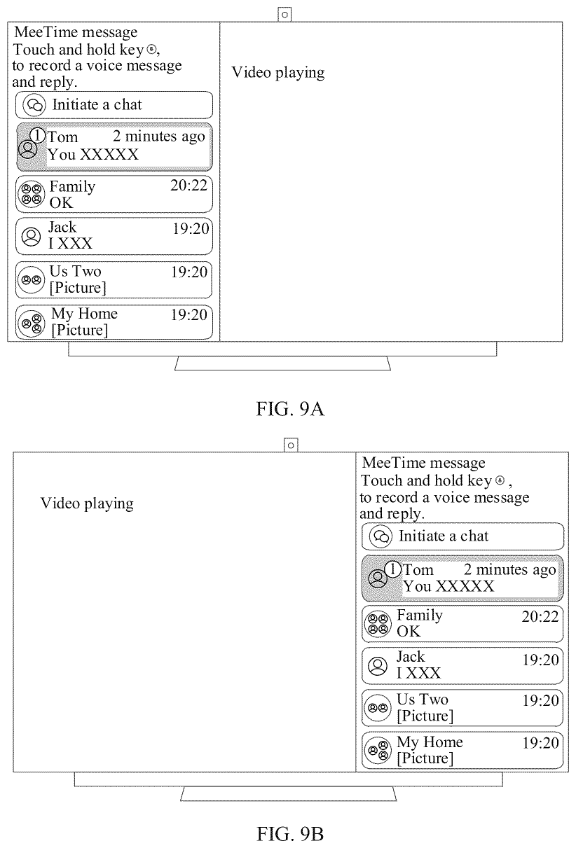

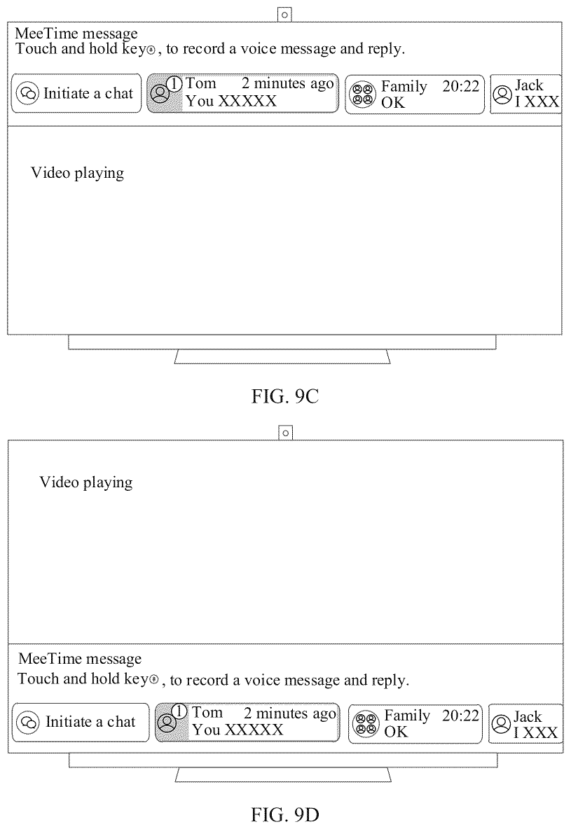

For example, FIG. 9A to FIG. 9D are schematic diagrams of four possible positions of a message list in a large screen.

As shown in FIG. 9A to FIG. 9D, a display position of a message list in a large screen may be shown in FIG. 9A, FIG. 9B, FIG. 9C, and FIG. 9D. The message list in FIG. 9A is displayed on a left side of the large screen, the message list in FIG. 9B is displayed on a right side of the large screen, the message list in FIG. 9C is displayed on an upper side of the large screen, and the message list in FIG. 9D is displayed on a lower side of the large screen.

It may be understood that the display position of the message list in the large screen may be preset by the user, or may be set by a system. Alternatively, the user may move the position of the message list in the large screen by using the remote control. This is not specifically limited in this embodiment of this application.

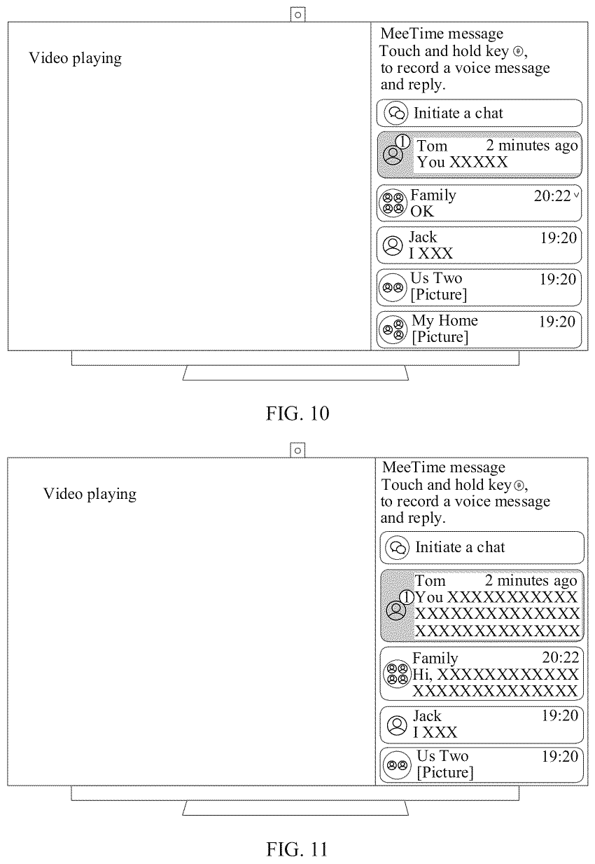

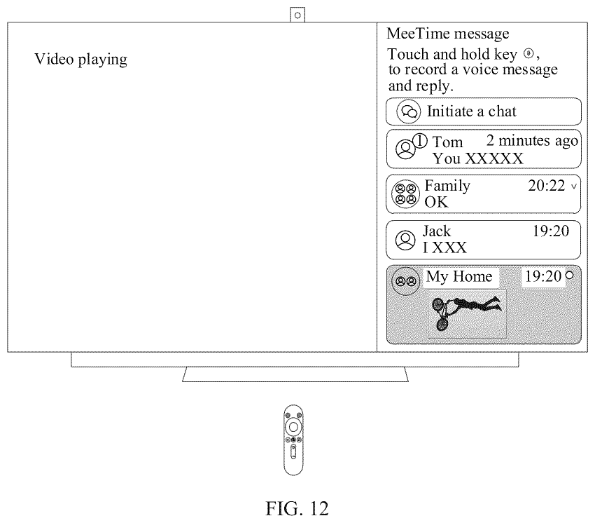

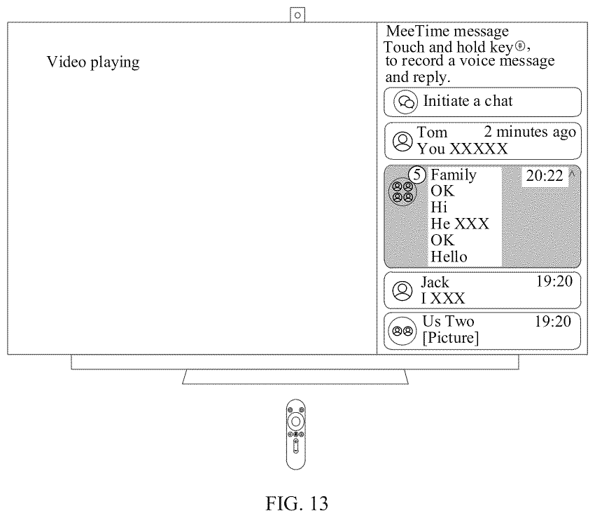

For example, FIG. 10 to FIG. 13 are schematic diagrams of four possible message display manners in a message list. In FIG. 10, displaying a message in a message list is described by using an example in which sizes of message boxes of all messages are the same. In FIG. 1I, displaying a message in a message list is described by using an example in which a size of a message box of each message may be adaptively scaled based on a length of each message. In FIG. 12, displaying a message in a message list is described by using an example in which a picture preview may be displayed. In FIG. 13, displaying a message in a message list is described by using an example in which a plurality of messages may be displayed. The following separately describes FIG. 10 to FIG. 13.

As shown in FIG. 10, displaying a message in a message list may be: sizes of message boxes of all messages are the same. For example, when a message list is displayed on a large screen, sizes of message boxes in which messages sent by a contact Tom and a contact Jack are located are the same as a size of a message box in which a message sent by a group chat “Family” is located and sizes of message boxes in which pictures respectively sent by a group chat “Us Two” and a group chat “My Home” are located. Optionally, if the size of the message box is insufficient to display all message content, the message may be truncated based on the size of the message box. This is not limited in embodiments of this application. In this way, a setting program of the message box may be simplified, and computing resources are saved.

As shown in FIG. 11, displaying a message in a message list may be: a size of a message box of each message is adaptively scaled based on a length of each message. For example, when a message list is displayed on a large screen, latest message content received from a contact Tom is the longest, latest message content received from a group chat “Family” is the second longest, and latest message content received from a contact Jack and a group chat “Us Two” is shorter. As shown in FIG. 1I, a size of each message box may be adjusted based on a length of the latest message received from each contact. A message box of the contact Torn is the largest, a message box of the group chat “Family” is the second largest, and message boxes of the contact Jack and the group chat “Us Two” are smaller. It may be understood that message boxes of different sizes may alternatively be fixedly disposed. For example, N display boxes of different sizes are preset, and a proper message box is selected from the N display boxes of different sizes for a message based on an amount of message content. This is not specifically limited in this embodiment of this application. In this way, as much message content may be displayed in the message box for the user as possible, to facilitate preview of the user.

As shown in FIG. 12, displaying a message in a message list may be: when a message in a message box is in a form of a picture, by moving a focus by using a key of a remote control to select a message box in which the picture is located, a picture preview state may be displayed. For example, the user may move a focus from the interface shown in FIG. 10 to the group chat “My Home” shown in FIG. 12 by using a key of the remote control, and a latest message received from the group chat “My Home” is a picture. In this case, a picture preview may be displayed in a message box in which the group chat “My Home” is located, so that the user can preview the picture.

As shown in FIG. 13, displaying a message in a message list may be: when there are a plurality of messages in a message box, by moving a focus by using a key of a remote control to select a message box in which the plurality of messages are located, the plurality of messages may be displayed. For example, the user may move a focus from the interface shown in FIG. 10 to the message box of the group chat “Family” shown in FIG. 13 by using a key of the remote control. If five latest messages are received from the group chat “Family”, the five messages may be displayed in the message box in which the group chat “Family” is located. In this way, as much message content may be displayed in the message box for the user as possible, to facilitate preview of the user.

It may be understood that, if an excessively long latest message or excessive latest messages are received from the group chat “Family”, a part of message content may be truncated for display based on a size of the message box. This is not specifically limited in this embodiment of this application.

It may be understood that how to display a message in a message list may be preset by the user, or may be set by a system. This is not specifically limited in this embodiment of this application.

It should be noted that, in any user interface shown in FIG. 10 to FIG. 13, if a latest message received from a contact A is a voice (not shown in the figure), the user may further trigger, by using the remote control, playing the voice or converting the voice into text for display, so that the user may conveniently browse the latest received message. For example, if the user keeps the focus of the remote control in a message box of the contact A for a preset period of time, the latest voice received from the contact A is played or the voice of the contact A is converted into at least one word for display. Certainly, a functional key may alternatively be defined in the remote control, and based on the functional key, playing the latest voice received from the contact A or converting the voice of the contact A into at least one word for display is triggered. This is not specifically limited in this embodiment of this application.

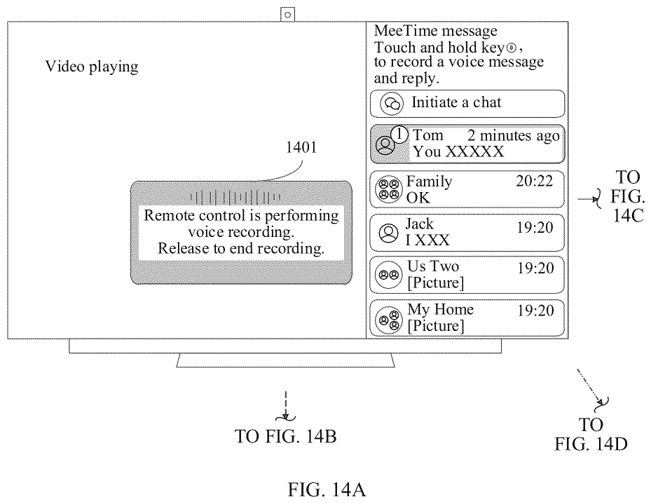

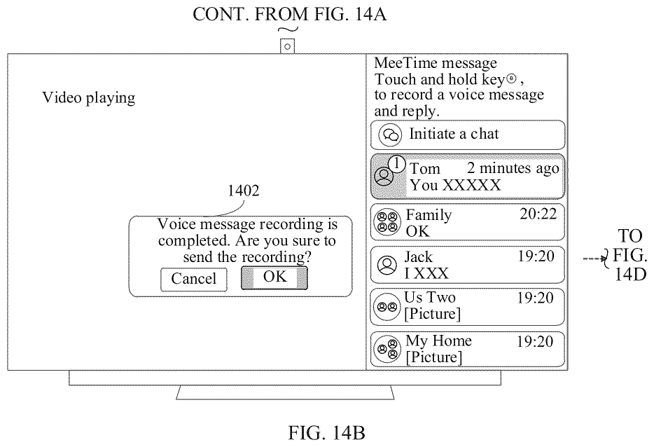

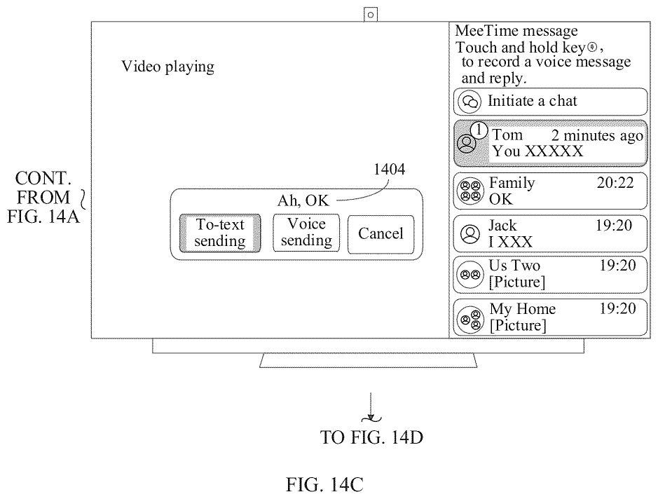

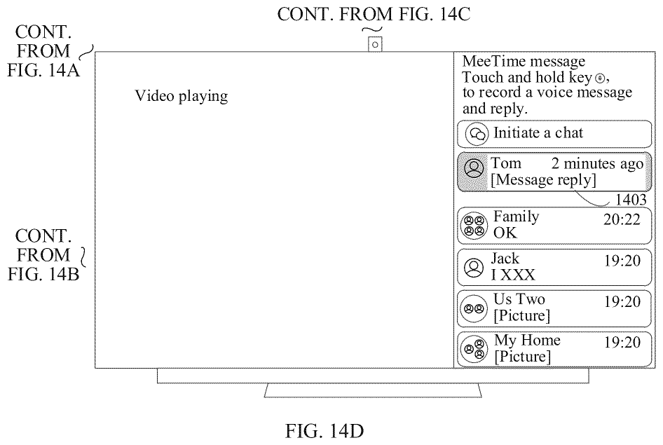

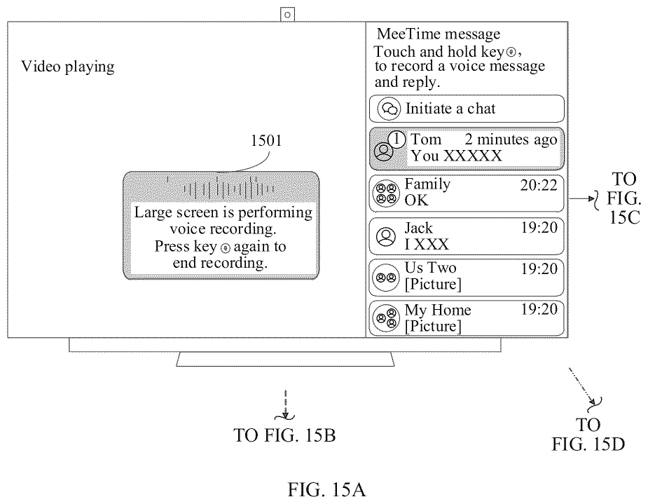

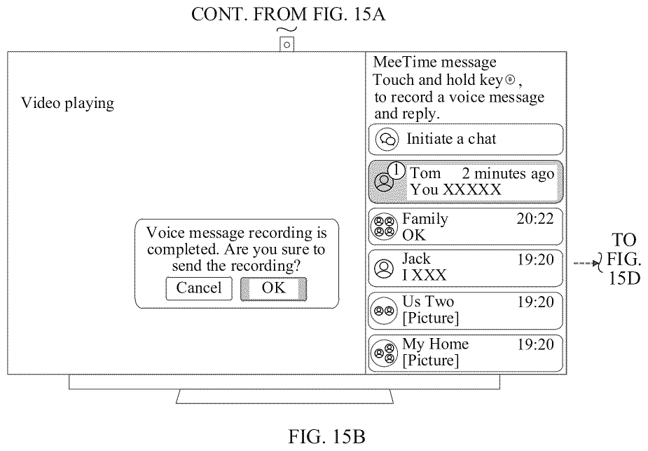

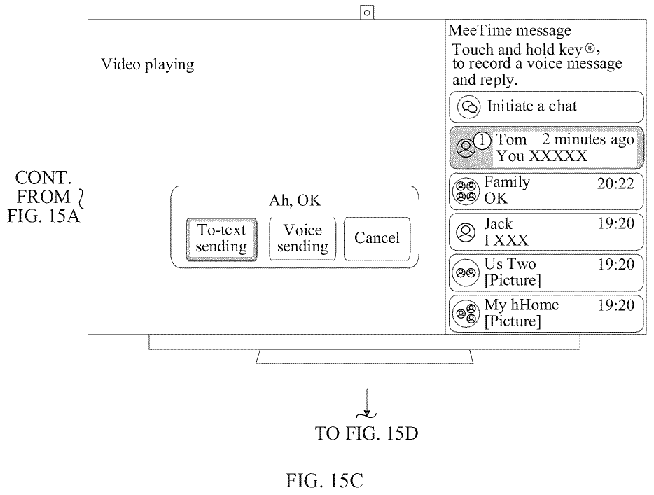

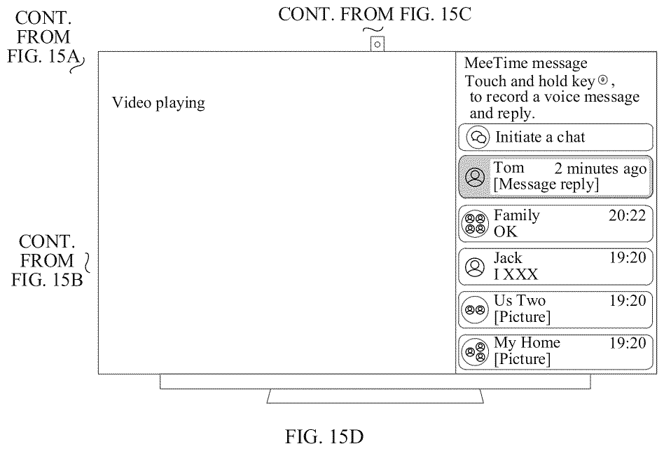

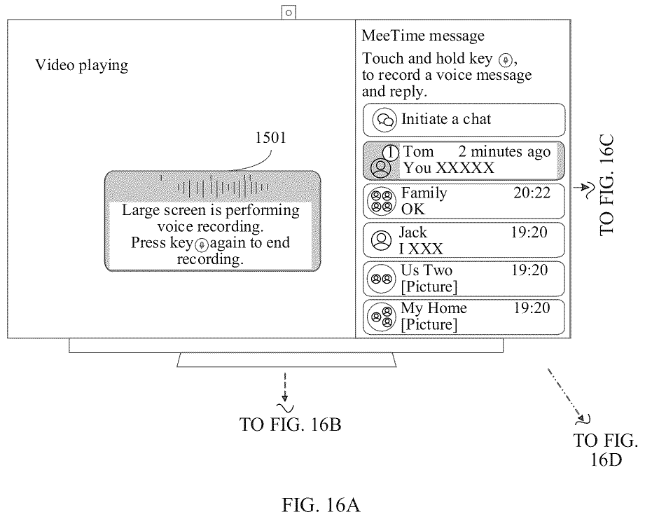

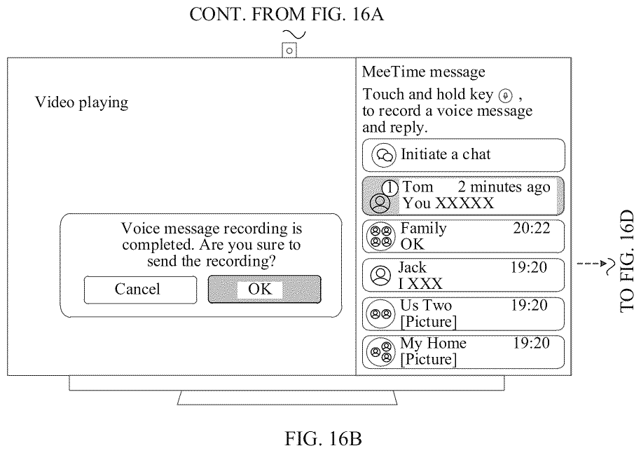

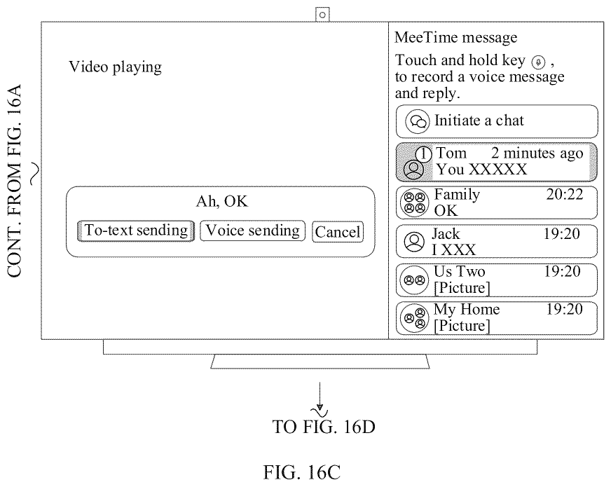

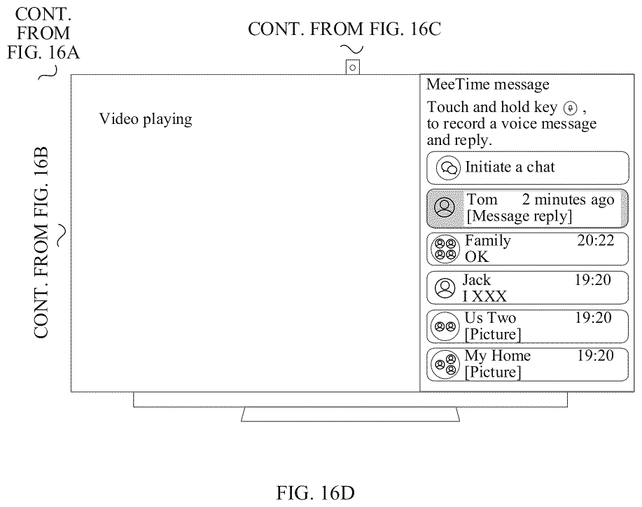

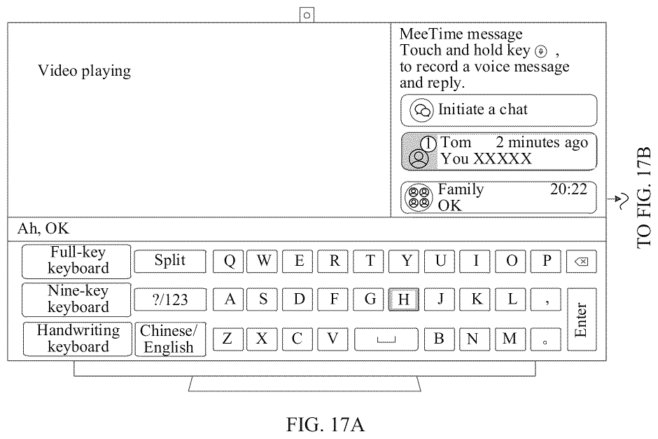

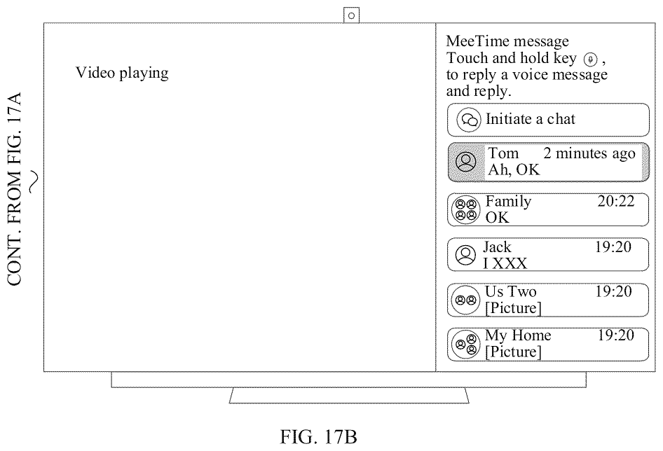

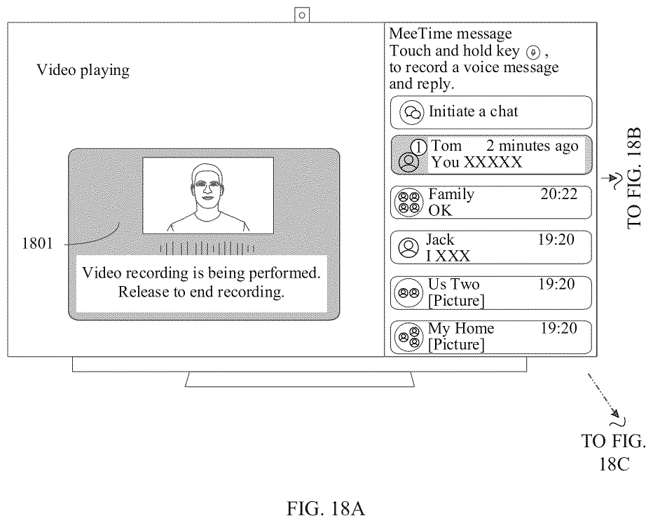

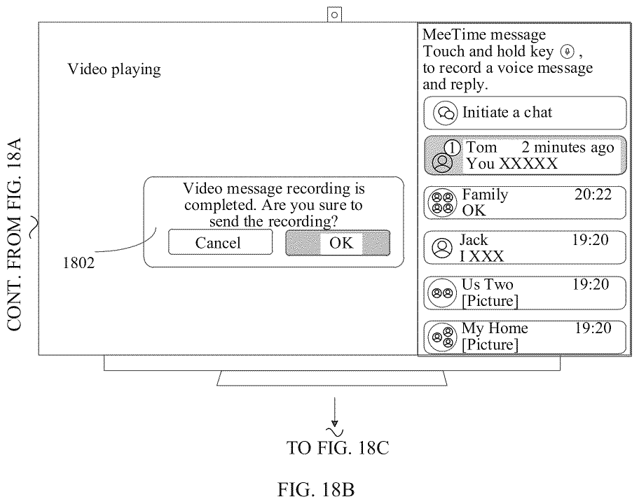

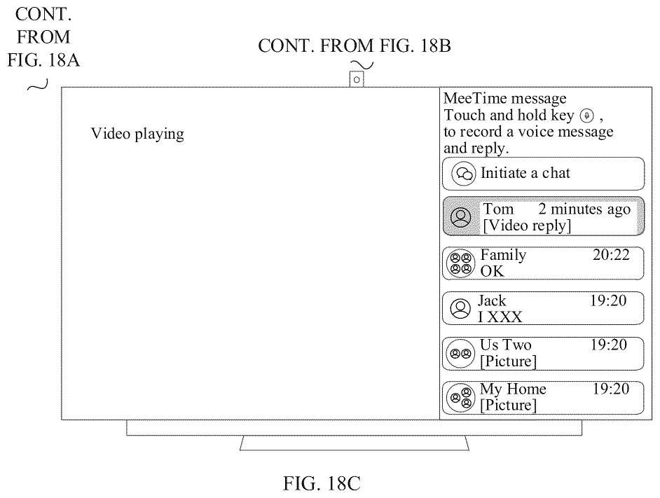

In the phase of performing a quick reply based on the message list, how to perform a quick reply by the user in the message list is not limited. For example, FIG. 14A to FIG. 18C are schematic diagrams of six possible manners of performing a quick reply based on a message list. FIG. 14A to FIG. 14D show a quick reply performed by recording by a remote control, FIG. 15A to FIG. 15D show a quick reply performed by recording by a large screen, FIG. 16A to FIG. 16D show another quick reply performed in a voice manner, FIG. 17A and FIG. 17B show a quick reply performed by entering words, and FIG. 18A to FIG. 18C show a quick reply performed through video recording.

As shown in FIG. 14A to FIG. 14D, when a message list is displayed on a large screen, the user may perform a quick reply by recording by a remote control. A specific manner of the quick reply may include three forms.

Manner 1: As shown in FIG. 14A, when the message list is displayed on the large screen, the user may move a focus to a message box of a contact Tom by using a key of the remote control, and touch and hold a key like a “voice key” having a voice recording function in the remote control, to record a voice replied by the user by using the remote control. During recording, the large screen may display prompt information “The remote control is recording, and release to end recording” 1401 shown in FIG. 14A.

After the user releases the “voice key”, voice recording ends. As shown in FIG. 14B, the large screen pops up a query message box 1402, where the query message box 1402 may include prompt information “Voice message recording is completed. Are you sure to send the recording?”, an OK button, and a cancel button. The user may select the OK button by using the remote control to send the voice, and open a sending interface shown in FIG. 14D. It should be noted that a display manner of a reply message 1403 in FIG. 14D may be a voice identifier, or may be words obtained after voice conversion. This is not specifically limited in this embodiment of this application.

It may be understood that if the user accidentally touches a voice recording button of the remote control and does not want to perform a voice reply, the user may cancel reply by using the cancel button shown in FIG. 14B.

Manner 2: A process related to FIG. 14A is the same as the process in Manner 1, and details are not described herein again. Different from Manner 1, after voice recording ends, as shown in FIG. 14C, a query message box 1404 of the large screen may include a voice-to-word send button, a voice send button, and a cancel button. The user may select the voice-to-word button by using the remote control, and the large screen may convert the voice into words, and reply the words, to open an interface shown in FIG. 14D. Content related to FIG. 14D is similar to that in Manner 1, and details are not described again. Optionally, after the user triggers the voice-to-word button, the converted words may be displayed in the query message box 1404, to facilitate browsing by the user.

Manner 3: A process related to FIG. 14A is the same as the process in Manner 1, and details are not described herein again. Different from Manner 1, in Manner 3, after voice recording is completed, the large screen may automatically send the voice, and open an interface shown in FIG. 14D without opening an interface shown in FIG. 14B or FIG. 14C. In this way, display interfaces in a reply process may be reduced, and computing resources of the large screen may be saved.

As shown in FIG. 15A to FIG. 15D, when a message list is displayed on a large screen, the user may perform a quick reply by recording by the large screen. A specific manner of the quick reply may include three manners. Procedures of the three manners are similar to those in FIG. 14A to FIG. 14D, and details are not described again. Different from recording by a remote control shown in FIG. 14A to FIG. 14D, in FIG. 15A to FIG. 15D, the user may trigger a voice reply by tapping a recording key in the remote control. Further, the large screen records a voice replied by the user. During recording, the large screen may display prompt information “The large screen is recording, and tap the recording key again to end recording” 1501 shown in FIG. 14A. After the user taps the recording key of the remote control again, voice recording ends.

In a process in which the large screen records the voice of the user, the large screen may automatically shield background sound of video content that is being played, to avoid interference of the sound played by the large screen to the voice of the user.

It should be noted that, in FIG. 14A to FIG. MD and FIG. 15A to FIG. 15D, the recording key of the remote control may be replaced with a confirm key. A specific functional key of the remote control is not limited in embodiments of this application.

The prompt content 1401 in FIG. 14A or the prompt content 1501 in FIG. 15A is displayed in a video playing region, which may interfere with the user in watching a video image. Therefore, further, a prompt mark prompting that recording is being performed may be disposed in a region of the message list.

For example, as shown in FIG. 16A, when voice recording is performed, a voice recording mark may be displayed at a left position 1601 of a message box, or as shown in FIG. 16B, a voice recording mark may be displayed at a right position 1602 of a message box. Certainly, the voice recording mark may alternatively be displayed at any position of the message box, or the voice recording mark may be displayed at any position outside the video playing region, to avoid impact on video playing.

In a possible implementation, the user may open an interface shown in FIG. 16A by pressing a left key of the remote control and perform voice recording. Further, the user may stop voice recording by pressing a right key or a confirm key of the remote control.

In a possible implementation, the user may open an interface shown in FIG. 16B by pressing a right key of the remote control and perform voice recording. Further, the user may stop voice recording by pressing a left key or a confirm key of the remote control.

FIG. 17A and FIG. 17B are schematic interface diagrams of quickly replying to a message through words according to an embodiment of this application.

As shown in FIG. 17A and FIG. 17B, when a message list is displayed on a large screen, the user may display a keyboard on the large screen by operating a key of a remote control, and perform a quick word reply based on the keyboard.

For example, as shown in FIG. 17A, on a message list page, the user may move a focus to a message box of a contact Tom that needs to be replied by using a key of the remote control, and trigger a keyboard to pop up on the large screen based on a confirm key of the remote control. The user may use the keyboard to enter “Ah, OK”. After entering is completed, the user selects a confirm key on the keyboard by using a key of the remote control to send the words, to open an interface shown in FIG. 17B, so that the sent “Ah, OK” may be displayed in the message box of the contact Tom.

FIG. 18A to FIG. 18C are schematic interface diagrams of quickly replying to a message through a video according to an embodiment of this application:

As shown in FIG. 18A to FIG. 18C, when a message list is displayed on a large screen, the user may perform video recording by operating a key of a remote control to quickly reply to a message.

For example, as shown in FIG. 18A, on a message list page, the user may move a focus to a message box of a contact Tom that needs to be replied by using a key of the remote control, and touch and hold a voice key in the remote control to trigger the large screen or the remote control to perform video recording. During video recording, as shown in FIG. 18A, a prompt box 1801 prompting that recording is being performed may be displayed, for example, “A video is being recorded, and release to end recording” may be displayed in the prompt box. It may be understood that the prompt box 1801 may also be simplified as a video recording mark displayed in a region of the message list, which is similar to the display manner of the recording mark shown in FIG. 16A to FIG. 16D. Details are not described herein again.

After video recording ends, an interface shown in FIG. 18B may be displayed, including a query box prompting the user whether to send, where the query box may include an OK button or a cancel button, and the user may trigger the OK button to open the interface shown in FIG. 18C, or trigger the cancel button to cancel replying.

Alternatively, after video recording ends, the large screen may automatically send a video, not display the interface shown in FIG. 18B, and open an interface shown in FIG. 18C from the interface shown in FIG. 18A.

It may be understood that, in the foregoing embodiment, when the remote control is used to trigger opening the interface of the large screen, a specific used functional key of the remote control is not limited in embodiments of this application, provided that no conflict occurs between function control in the remote control. For example, the remote control in this embodiment of this application may be a common remote control, and the foregoing various controls are implemented by multiplexed a functional key of the remote control. Alternatively, the remote control may be a remote control to which a functional key is added, to implement the foregoing various controls in embodiments of this application. For example, FIG. 19 and FIG. 20 respectively show schematic diagrams of functional keys of two remote controls.

As shown in FIG. 19, FIG. 19 may be a common remote control. In this embodiment of this application, a multiplexing function may be defined for each key of the remote control.

For example, a recording key 1901 may have the following functions:

1. Touch and hold to start voice recording, and release to end recording.

2. Tap to start voice recording, and then tap again to end recording.

3. Touch and hold to pop up video recording, touch and hold again to perform video recording, and release to end recording.

4. Press once to start voice recording, press twice to start video recording, and press three times to enable a keyboard.

A confirm key 1902 may include the following functions:

1. Touch and hold to start voice recording, and release to end recording.

2. Touch and hold to pop up a keyboard.

It may be understood that in this embodiment of this application, only some examples are provided for describing functions of the keys, and some implementations of the foregoing functions conflict with each other. In a specific application, an adaptive manner may be selected with reference to a requirement to ensure that functions of the keys of the remote control do not conflict with each other. Certainly, the foregoing functions may alternatively be implemented by multiplexing a left key, a right key, a volume key, or a menu key in the remote control. This is not specifically limited in this embodiment of this application.

FIG. 20 is a schematic functional diagram of keys of another remote control according to an embodiment of this application.

As shown in FIG. 20, a text reply key 2002 and a video reply key 2003 are added to the remote control shown in FIG. 20 based on the keys of the remote control in FIG. 19.

In this case, the user may perform a voice reply by triggering a voice reply key 2001, perform a word reply by triggering the text reply key 2002, and perform a video reply by triggering the video reply key 2003.

It may be understood that in this embodiment of this application, only some examples are provided for describing functions of the keys. In a specific application, an adaptive manner may be selected with reference to a requirement to ensure that functions of the keys of the remote control do not conflict with each other. Certainly, the foregoing functions may alternatively be implemented by multiplexing a left key, a right key, a volume key, or a menu key in the remote control. This is not specifically limited in this embodiment of this application.

It should be noted that FIG. 8A to FIG. 18C are described by using an example in which the terminal is a large screen. The terminal may further include a mobile phone. Implementing a quick reply by the mobile phone is similar to that by the large screen, Different from that of the large screen, in the mobile phone, when a user triggers opening different interfaces, tapping, touching, voice control, or the like may be used instead of a remote control. The following provides brief description by using an example in which the terminal is a mobile phone.

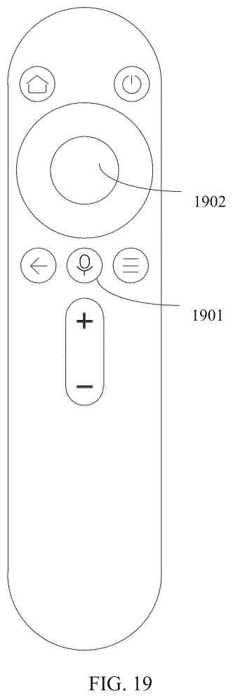

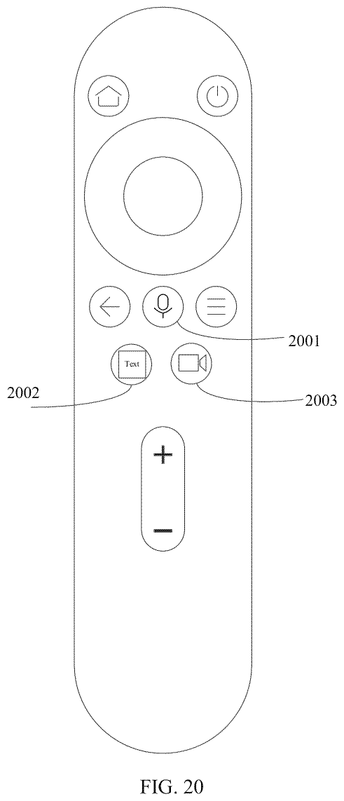

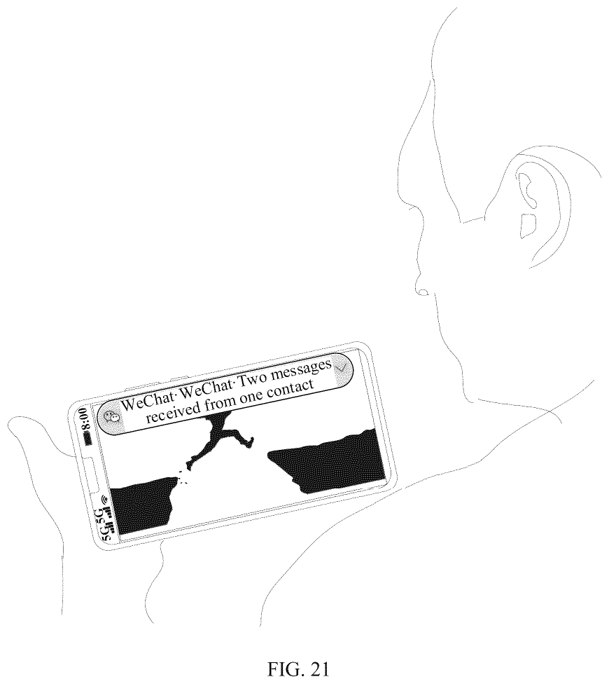

FIG. 21 is a schematic diagram of a scenario according to an embodiment of this application. As shown in FIG. 21, when a user watches a video on a smartphone, a new message pop-up box pops up.

For example, FIG. 22A and FIG. 22B are schematic interface diagrams when a mobile phone replies to a message in the conventional technology. As shown in FIG. 22A, when watching a video, a user receives a notification message of WeChat, where the notification message may prompt a contact and some message content. The user may tap the notification to open a specific chat interface of the contact shown in FIG. 22B, and the user further replies in the specific chat interface.

However, if the user wants to check whether another message needs to be replied after replying to the message, the user needs to exit the current chat page, and then separately open another chat interface to perform a reply operation, which is complex to operate.

Based on this, an embodiment of this application provides a message reply method. When watching a video in a mobile phone, if a user receives a chat message of a social application, the user may trigger opening an interface including a message list. In the message list, the user may trigger a quick reply to any contact without opening a specific chat page.

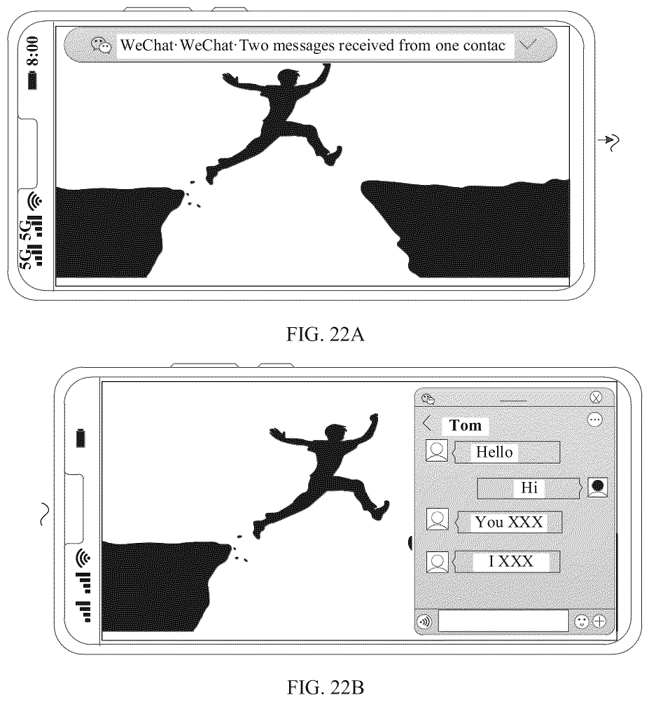

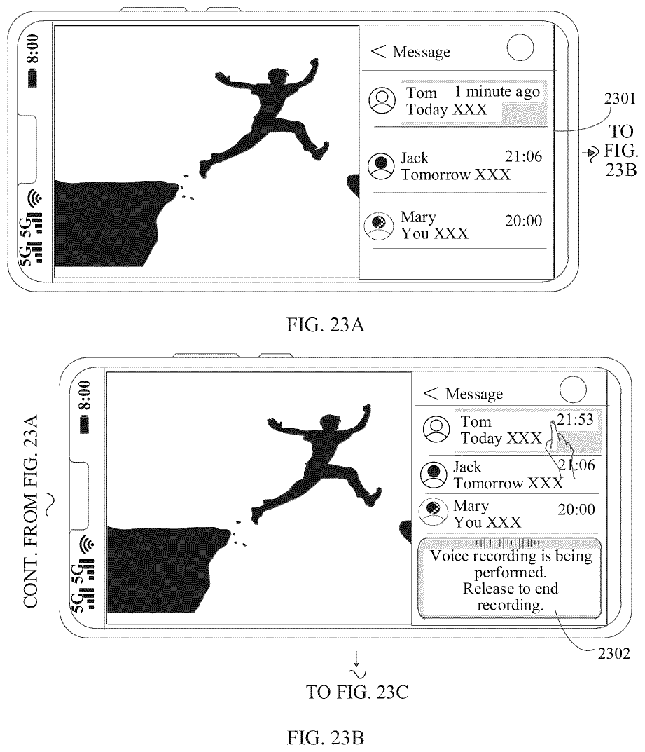

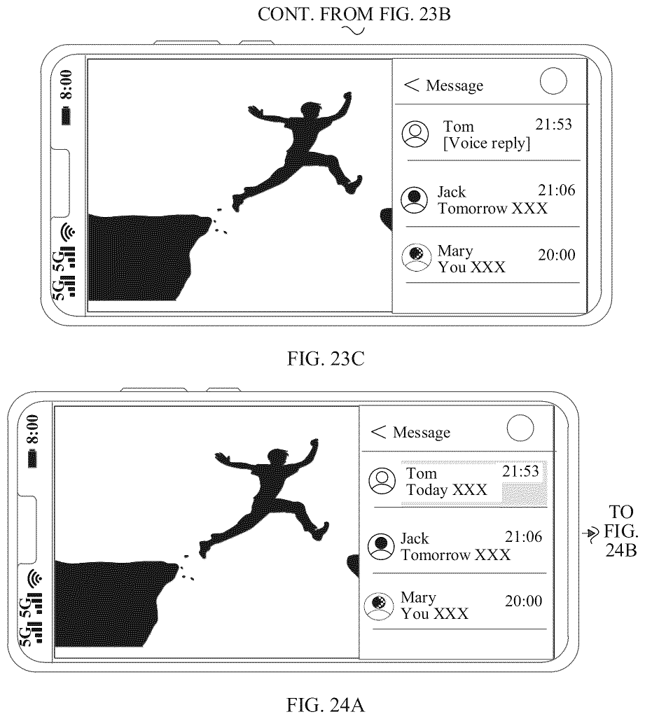

For example, FIG. 23A to FIG. 26C show schematic interface diagrams when a user replies in voice, voice-to-word, text, and video manners, which are separately described below.

FIG. 23A to FIG. 23C are schematic interface diagrams of a manner in which a mobile phone quickly replies to a message through a voice according to an embodiment of this application.

The user may trigger a notification message in FIG. 23A to open an interface shown in FIG. 23A Different from opening a chat page in an interface shown in FIG. 22B, in FIG. 23A a message list 2301 is displayed, and the message list may display latest messages received from a plurality of contacts. Further, as shown in FIG. 23B, the user may trigger a quick reply to a contact Tom by touching and holding, increasing a pressing force, or the like. The quick reply may be in a voice manner, and the mobile phone may record a voice of the user, and may display a prompt box 2302 prompting that recording is being performed. In an example that the user touches and holds a message box of the contact Tom to trigger voice recording, the prompt box 2302 may display “Voice recording is being performed, and release to end recording”. After the user releases, the mobile phone may send out a recorded voice and open a message reply interface shown in FIG. 23C. In the message reply interface, a voice reply mark or text obtained after voice conversion may be displayed in the message box of the contact Tom. This is not specifically limited in this embodiment of this application.

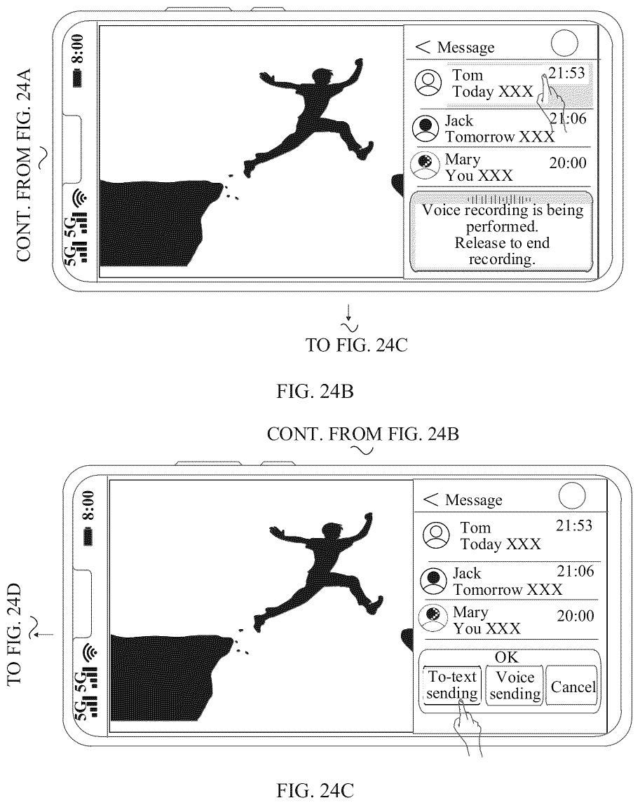

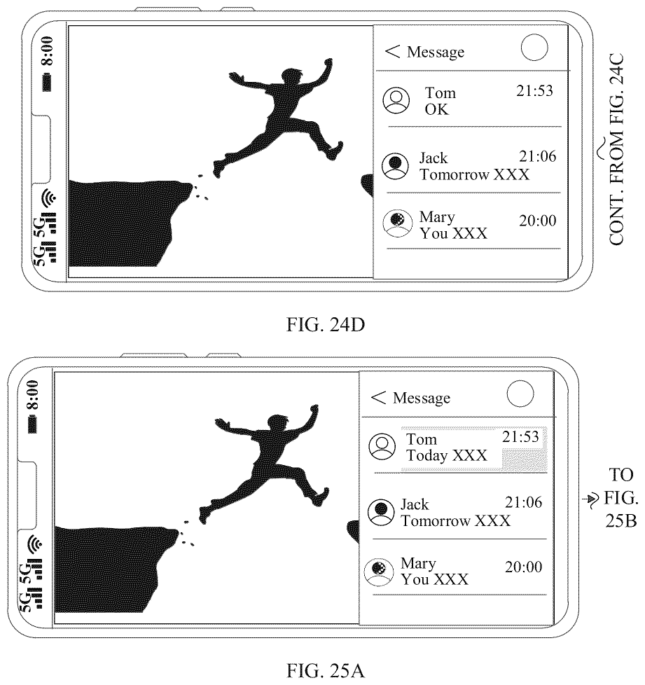

FIG. 24A to FIG. 24D are schematic interface diagrams of a manner in which a mobile phone quickly replies to a message through voice-to-text according to an embodiment of this application.

For processes corresponding to FIG. 24A and FIG. 24B, refer to descriptions of the processes corresponding to FIG. 23A and FIG. 2313. Details are not described herein again. Different from FIG. 23B, after recording ends in FIG. 24B, the mobile phone pops up a prompt box shown in FIG. 24C, to prompt the user to use “voice-to-word sending”, “voice sending”, or “cancel”. If the user triggers “voice-to-word sending”, the mobile phone sends content obtained after a voice is converted into at least one word to the contact Tom, and open an interface shown in FIG. 24D, where the sent word is displayed in the message box of the contact Tom.

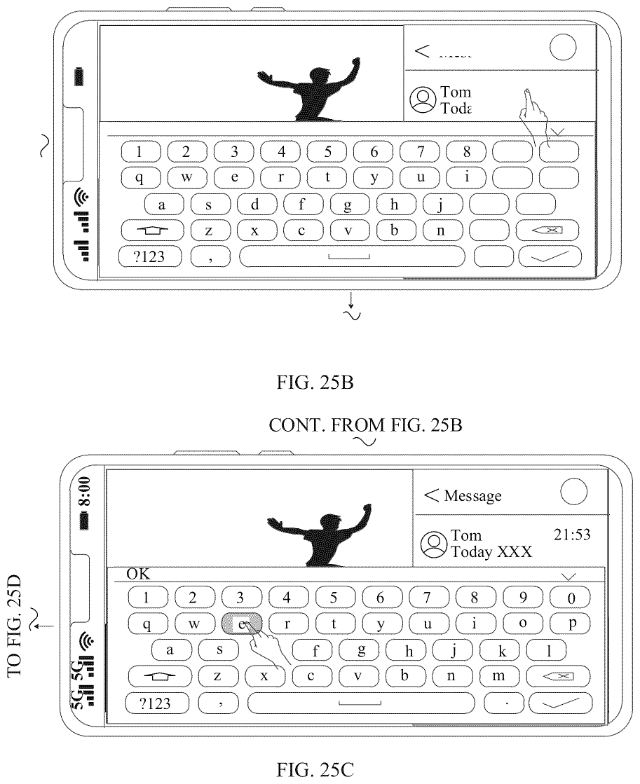

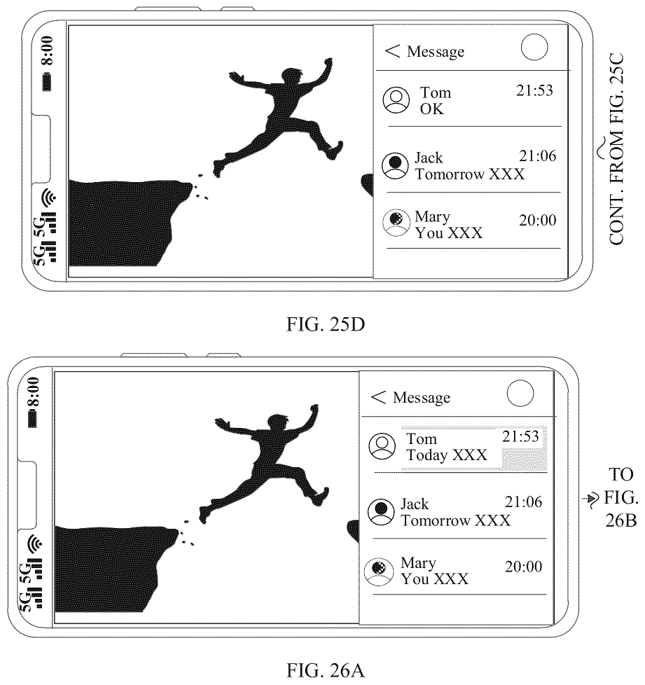

FIG. 25A to FIG. 25D are schematic interface diagrams of a manner in which a mobile phone quickly replies to a message through text according to an embodiment of this application.

The user may trigger the notification message in FIG. 19, and open an interface shown in FIG. 25A. In FIG. 25A, a message list is displayed, and the message list may display latest messages received from a plurality of contacts. Further, as shown in FIG. 25B, the user may trigger a quick reply to a contact Tom by touching and holding, increasing a pressing force, or the like. The quick reply may be in a text manner, and a keyboard pops up in the mobile phone. As shown in FIG. 25C, the user may enter reply content based on the keyboard, and after tapping sending, the mobile phone may open a message reply interface shown in FIG. 25D. In the message reply interface, reply text may be displayed in a message box of the contact Tom. This is not specifically limited in this embodiment of this application.

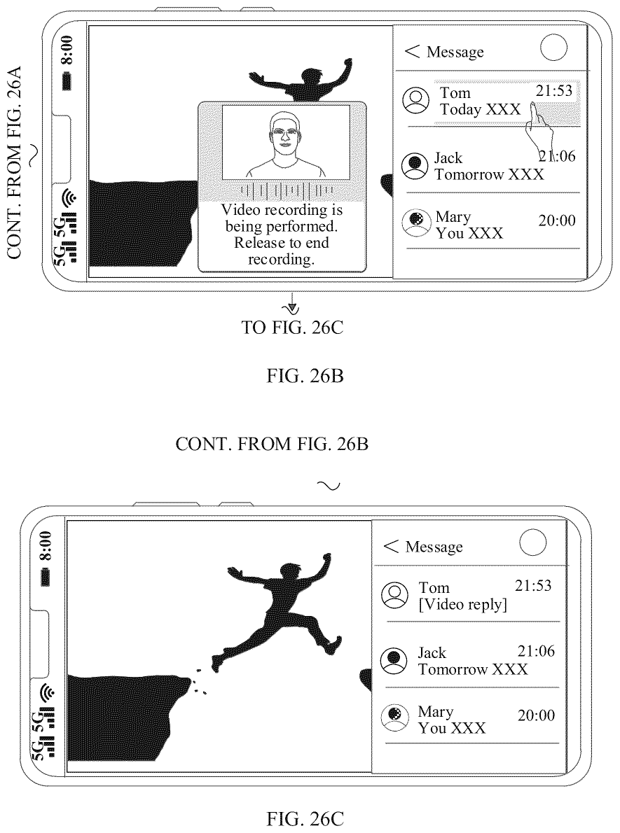

FIG. 26A to FIG. 26C are schematic interface diagrams of a manner in which a mobile phone quickly replies to a message through a video according to an embodiment of this application.

The user may trigger a notification message in FIG. 26A, and open an interface shown in FIG. 26A. In FIG. 26A, a message list is displayed, and the message list may display latest messages received from a plurality of contacts. Further, as shown in FIG. 26B, the user may trigger a quick reply to a contact Tom by touching and holding, increasing pressing force, or the like. The quick reply may be in a video manner, and the mobile phone may record a video of the user and may display a prompt box prompting that video recording is being performed. In an example that the user touches and holds a message box of the contact Tom to trigger video recording, the prompt box may display “Video recording is being performed, and release to end recording”. After the user releases, the mobile phone may send out a video and open a message reply interface shown in FIG. 26C. In the message reply interface, a video reply mark may be displayed in the message box of the contact Tom. This is not specifically limited in this embodiment of this application.

It may be understood that, in the foregoing several quick reply manners, the mobile phone may support only one of a voice reply, a word reply, or a video reply. Alternatively, the mobile phone may support a plurality of functions of a voice reply, a word reply, or a video reply. The user may trigger a quick reply in any possible manner like touching and holding, pressing, tapping, touching, voice, or a gesture, provided that the quick reply does not conflict with functions of trigger manners in the mobile phone. This is not specifically limited in this embodiment of this application.

In conclusion, in this embodiment of this application, when a user watches a video in a mobile phone, if the user receives a chat message of a social application, the user may trigger opening an interface including a message list. In the message list, the user may trigger a quick reply to any contact without opening a specific chat page. Further, the mobile phone may continuously play the video in the foregoing process without affecting video watching by the user.

It may be understood that an implementation idea of the mobile phone is consistent with that of a quick reply in the large screen, and an idea used in the large screen may also be adaptively added to the mobile phone. Details are not described herein again.

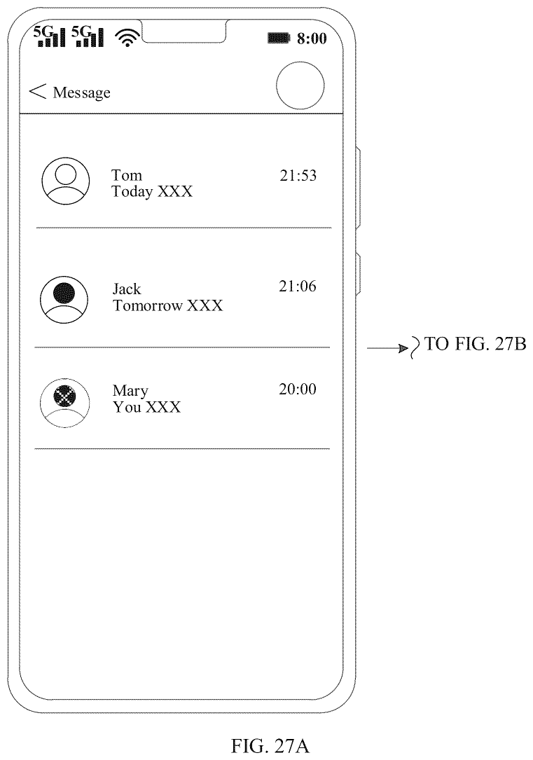

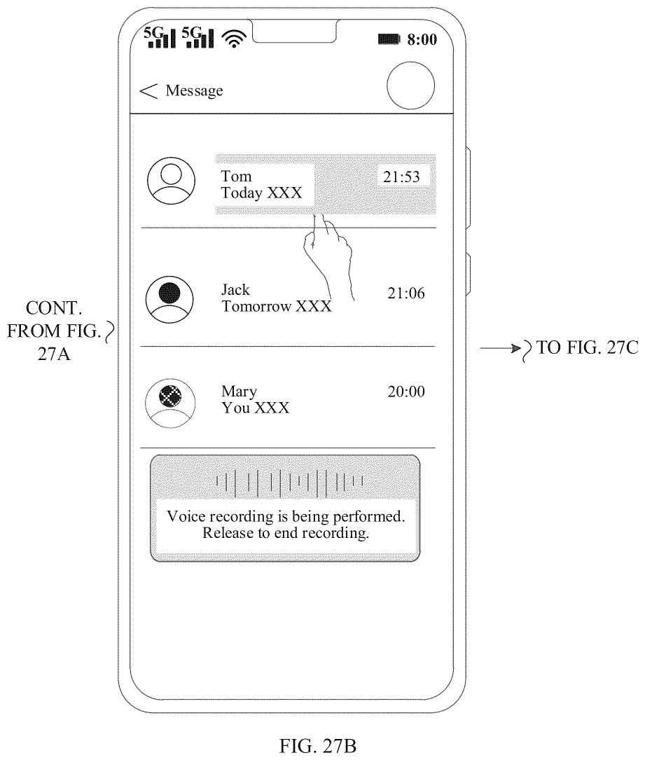

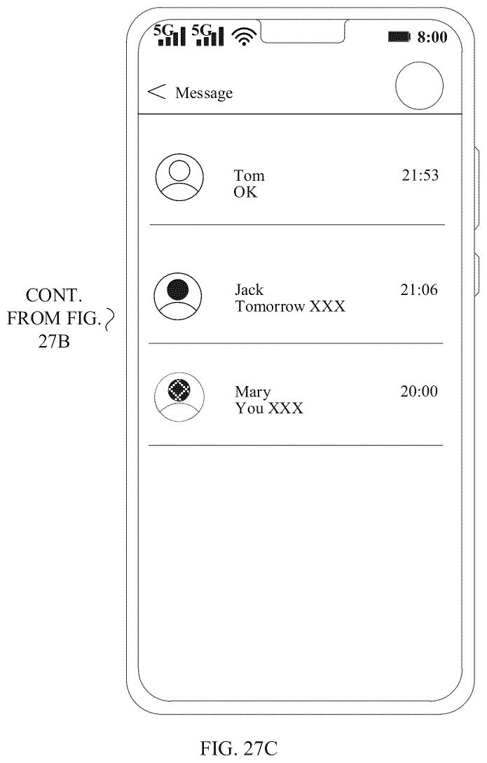

It should be noted that, in a common social application interface of the mobile phone, the mobile phone may also use a quick reply. For example, as shown in FIG. 27A, in a social application interface of the mobile phone, a message list shown in FIG. 27A may be displayed. Further, as shown in FIG. 27B, the user may trigger, by touching and holding a message box of a contact Torn, replying to the contact Torn by voice, and open an interface after replying shown in FIG. 27C. It may be understood that the user may alternatively reply by converting a voice into words, through words, or through a video. For details, refer to any one of the foregoing quick reply manners. A difference is that in this embodiment of this application, an interface of the mobile phone is an interface of a social application, and content related to video playing does not need to be referred to.

In this way, the user may implement a quick reply in the message list in the social application.

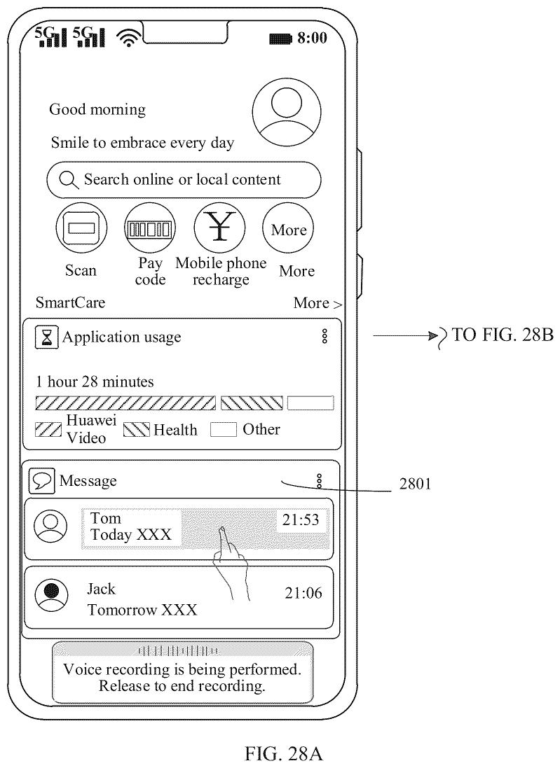

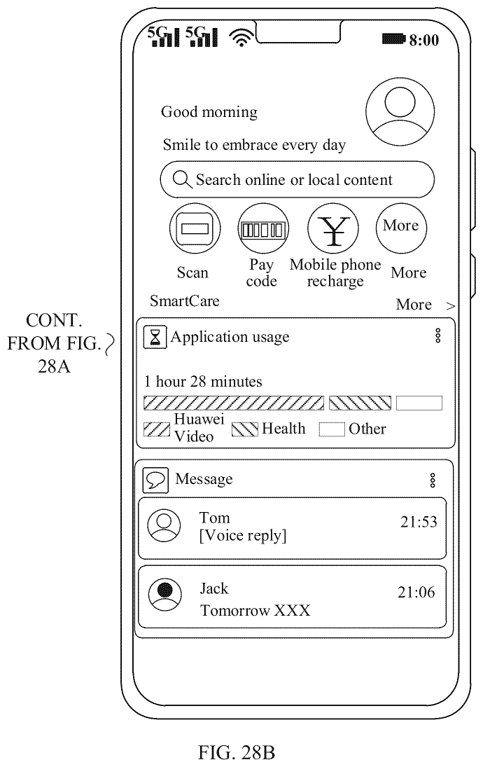

In a common leftmost screen interface of the mobile phone, the mobile phone may also use a quick reply. For example, as shown in FIG. 28A, in a leftmost screen interface of the mobile phone, a message list 2801 shown in FIG. 28A may be displayed. Further, the user may trigger, by touching and holding a message box of a contact Tom, replying to the contact Toni by voice, and open an interface after replying shown in FIG. 28B, It may be understood that the user may alternatively reply by converting a voice into words, through words, or through a video. For details, refer to any one of the foregoing quick reply manners. A difference is that in this embodiment of this application, an interface of the mobile phone is an interface of a leftmost screen, and content related to video playing does not need to be referred to.

In this way, the user may implement a quick reply in the leftmost screen.

It should be noted that the foregoing embodiments may be used separately, or may be used in combination to achieve different technical effects.

In the foregoing embodiments provided in this application, the method provided in embodiments of this application is described from a perspective that an electronic device serves as an execution body. To implement the functions in the method provided in the foregoing embodiments of this application, the electronic device may include a hardware structure and/or a software module, to implement the functions in a form of the hardware structure, the software module, or a combination of the hardware structure and the software module. Whether a function in the foregoing functions is performed by using the hardware structure, the software module, or the combination of the hardware structure and the software module depends on particular applications and design constraints of the technical solutions.

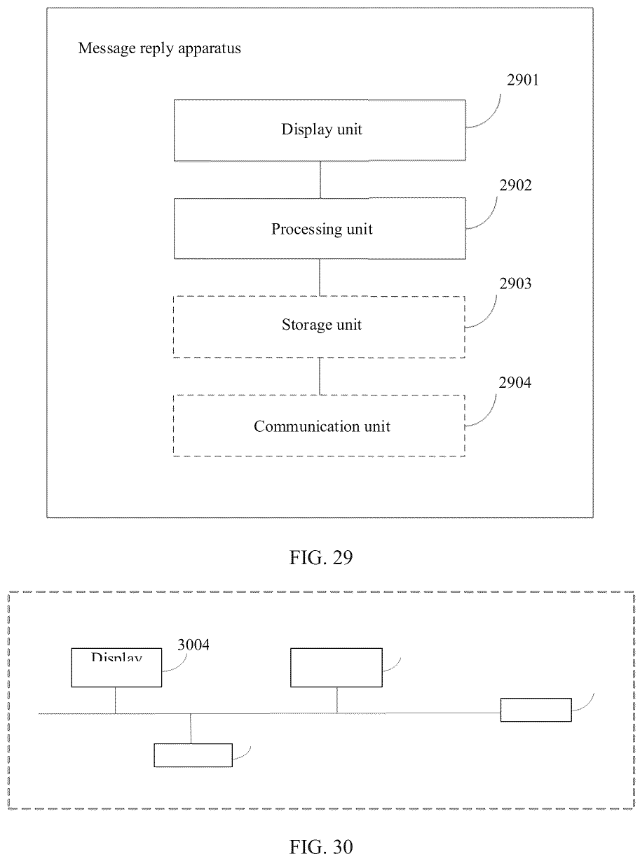

As shown in FIG. 29, FIG. 29 is a schematic diagram of a structure of a message reply apparatus according to an embodiment of this application. The message reply apparatus may be an electronic device in embodiments of this application, or may be a chip or a chip system in an electronic device. The message reply apparatus includes: a display unit 2901 and a processing unit 2902, where the display unit 2901 is configured to display a first user interface including a message list; the processing unit 2902 is configured to receive a first trigger operation performed by a user on a first message box in the message list, where the first trigger operation is for triggering replying to a first contact corresponding to the first message box; the processing unit 2902 is further configured to obtain, based on the first trigger operation, a reply message to the first contact when the first user interface is displayed; and the processing unit 2902 is further configured to send the reply message to the first contact.

For example, the message reply apparatus is an electronic device or a chip or a chip system applied to an electronic device. The display unit 2901 is configured to support a message display apparatus in performing the display step in the foregoing embodiment, and the processing unit 2902 is configured to support the message reply apparatus in performing the processing step in the foregoing embodiment.

The processing unit 2902 may be integrated with the display unit 2901, and the processing unit 2902 may communicate with the display unit 2901.

In a possible implementation, the message reply apparatus may further include a storage unit 2903. The storage unit 2903 may include one or more memories. The memory may be a component configured to store a program or data in one or more devices or circuits.

The storage unit 2903 may exist independently, and is connected to the processing unit 2902 by using a communication bus. The storage unit 2903 may alternatively be integrated with the processing unit 2902.

For example, the message reply apparatus may be a chip or a chip system of the electronic device in embodiments of this application. The storage unit 2903 may store computer executable instructions of the method of the electronic device, so that the processing unit 2902 performs the method of the electronic device in the foregoing embodiments. The storage unit 2903 may be a register, a cache, or a random access memory (random access memory. RAM), and the storage unit 2903 may be integrated with the processing unit 2902. The storage unit 2903 may be a read-only memory (read-only memory, ROM) or another type of static storage device that can store static information and instructions, and the storage unit 2903 may be independent of the processing unit 2902.

In a possible implementation, the display unit 2901 is specifically configured to display the first user interface including the message list; the processing unit 2902 is specifically configured to receive the first trigger operation performed by the user on the first message box in the message list, where the first trigger operation is for triggering replying to the first contact corresponding to the first message box; the processing unit 2902 is further specifically configured to obtain, based on the first trigger operation, the reply message to the first contact when the first user interface is displayed; and the processing unit 2902 is further specifically configured to send the reply message to the first contact.

In a possible implementation, the message reply apparatus may further include a communication unit 2904. The communication unit 2904 is configured to support the message reply apparatus in interacting with another device. For example, when the message reply apparatus is a terminal device, the communication unit 2904 may be a communication interface or an interface circuit. When the message reply apparatus is a chip or a chip system in a terminal device, the communication unit 2904 may be a communication interface. For example, the communication interface may be an input/output interface, a pin, or a circuit.

The apparatus in this embodiment may be correspondingly configured to perform the steps performed in the foregoing method embodiments. Implementation principles and technical effects of the apparatus are similar to those in the foregoing embodiments and are not described herein again.

FIG. 30 is a schematic diagram of a hardware structure of a message reply apparatus according to an embodiment of this application. Refer to FIG. 30, the message reply apparatus includes a memory 3001, a processor 3002, and a display 3004. The communication apparatus may further include an interface circuit 3003. The memory 3001, the processor 3002, the interface circuit 3003, and the display 3004 may communicate with each other. For example, the memory 3001, the processor 3002, the interface circuit 3003, and the display 3004 may communicate with each other by using a communication bus. The memory 3001 is configured to store computer executable instructions, the processor 3002 controls execution, and the display 3004 performs display, so as to implement the message reply method provided in embodiments of this application.

In a possible implementation, the computer executable instructions in this embodiment of this application may also be referred to as application program code. This is not specifically limited in this embodiment of this application.

Optionally, the interface circuit 3003 may further include a transmitter and/or a receiver. Optionally, the processor 3002 may include one or more CPUs, or may be another general-purpose processor, a digital signal processor (digital signal processor, DSP), or an application-specific integrated circuit (application-specific integrated circuit, ASIC). The general-purpose processor may be a microprocessor, or the processor may be any conventional processor. Steps of the methods disclosed with reference to this application may be directly implemented by a hardware processor, or may be implemented by a combination of hardware and a software module in the processor.

An embodiment of this application further provides an electronic device, including a display, a processor, a memory, one or more sensors, a power supply, an application program, and a computer program. The foregoing components may be connected through one or more communication buses. The one or more computer programs are stored in the memory and are configured to be executed by the one or more processors. The one or more computer programs include instructions, and the instructions may be for enabling the electronic device to perform the steps of the interface display method in the foregoing embodiments.

For example, the processor may be specifically the processor 210 shown in FIG. 2, the memory may be specifically the memory 230 shown in FIG. 2, the display may be specifically the display unit 270 shown in FIG. 2, the sensor may be specifically one or more sensors in the sensor 201 shown in FIG. 2, and the power supply may be the power supply 250 shown in FIG. 2. This is not limited in embodiments of this application.

In addition, an embodiment of this application further provides a graphical user interface (graphical user interface, GUI) on an electronic device. The graphical user interface specifically includes a graphical user interface displayed when the electronic device performs the foregoing method embodiments.

All or some of the foregoing embodiments may be implemented by using software, hardware, firmware, or any combination thereof. When software is used to implement the foregoing embodiments, all or a part of the foregoing embodiments may be implemented in a form of a computer program product. The computer program product includes one or more computer instructions. When the computer program instructions are loaded and executed on a computer, all or some of the procedures or functions according to embodiments of the present invention are generated. The computer may be a general-purpose computer, a dedicated computer, a computer network, or other programmable apparatuses. The computer instructions may be stored in a computer-readable storage medium, or may be transmitted from one computer-readable storage medium to another computer-readable storage medium. For example, the computer instructions may be transmitted from one website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a, data storage device, like a server or a data center, integrating one or more usable media. The usable medium may be a magnetic medium (for example, a floppy disk, a hard disk, or a magnetic tape), an optical medium (for example, a DVD), or a semiconductor medium (for example, a solid-state drive (solid-state drive, SSD)). The solutions in the foregoing embodiments may all be combined for use if no conflict occurs.

The objectives, technical solutions, and beneficial effects of the present invention are further described in detail in the foregoing specific embodiments. It should be understood that the foregoing descriptions are merely specific embodiments of the present invention, but are not intended to limit the protection scope of the present invention. Any modification, equivalent replacement, or improvement made based on the technical solutions of the present invention shall fall within the protection scope of the present invention.

1.-33. (canceled)

34. A method implemented by an electronic device, wherein the method comprises:
displaying a first user interface comprising a message list and video content being played;
receiving, from a user on a first message box in the message list, a first trigger operation triggering a reply to a first contact corresponding to the first message box;
obtaining, based on the first trigger operation, a reply message to the first contact while displaying the first user interface, wherein the reply message comprises an audio message or a video message; and
sending, to the first contact, the reply message.

35. The method of claim 34, further comprising obtaining, based on the first trigger operation and either using a remote control or the electronic device, an audio or a video to generate the reply message.

36. The method of claim 35, further comprising displaying, after obtaining the audio or the video, a first control for canceling sending of the reply message, a second control for confirming sending of the reply message, and a third control for prompting to convert the reply message into at least one word for sending.

37. The method of claim 34, further comprising:
displaying the message list above the video content in a floating manner; or
displaying, in a split-screen manner, the message list and the video content.

38. The method of claim 34, further comprising further receiving, through a remote control, from the user, and on the first contact in the message list, the first trigger operation.

39. The method of claim 38, wherein before displaying the first user interface, the method further comprises:
displaying a second user interface comprising a control for displaying the message list and the video content being played; and
receiving a second trigger operation on the control.

40. The method of claim 38, further comprising:
identifying that the user has selected the first message box; and
scaling up, in response to identifying that the user has selected the first message box, the first message box to obtain a scaled-up first message box comprising a plurality of chat messages or picture thumbnails of the first contact.

41. The method of claim 34, wherein the first user interface is of a social application or of a leftmost screen.

42. The method of claim 34, wherein the message list comprises a plurality of message boxes for displaying one or more messages between different contacts and the user, and wherein the different contacts comprise a group or an individual.

43. The method of claim 42, wherein the message boxes have a same size, a size of each corresponding message box is scaled down or scaled up based on content in the corresponding message box, or each of the message boxes displays a thumbnail of a picture.

44. An electronic device comprising:
one or more memories configured to store instructions; and
one or more processors coupled to the one or more memories and configured to execute the instructions to cause the electronic device to:
display a first user interface comprising a message list and a video content being played;
receive, from a user on a first message box in the message list, a first trigger operation triggering replying to a first contact corresponding to the first message box;
obtain, based on the first trigger operation, a reply message to the first contact while displaying the first user interface, wherein the reply message comprises an audio message or a video message; and
send, to the first contact, the reply message.

45. The electronic device of claim 44, wherein the one or more processors are further configured to execute the instructions to cause the electronic device to obtain, based on the first trigger operation and either directly or using a remote control, audio or video to generate the reply message.

46. The electronic device of claim 45, wherein the one or more processors are further configured to execute the instructions to cause the electronic device to display, after obtaining the audio or the video, a first control for canceling sending of the reply message, a second control for confirming sending of the reply message, and a third control for prompting to convert the reply message into at least one word for sending.

47. The electronic device of claim 44, wherein the one or more processors are further configured to execute the instructions to cause the electronic device to:
display the message list above the video content in a floating manner; or
display, in a split-screen manner, the message list and the video content.

48. The electronic device of claim 44, wherein the one or more processors are further configured to execute the instructions to cause the electronic device to further receive, through a remote control, from the user, and on the first contact in the message list, the first trigger operation.

49. The electronic device of claim 48, wherein before displaying the first user interface, the one or more processors are further configured to execute the instructions to cause the electronic device to:
display a second user interface comprising a control for displaying the message list and the video content being played; and
receive a second trigger operation on the control.

50. The electronic device of claim 48, wherein the one or more processors are further configured to execute the instructions to cause the electronic device to:
identify that the user has selected the first message box; and
scale up, in response to identifying that the user has selected the first message box, the first message box to obtain a scaled-up first message box comprising a plurality of chat messages or picture thumbnails of the first contact.

51. The electronic device of claim 44, wherein the first user interface is of a social application or of a leftmost screen.

52. The electronic device of claim 44, wherein the message list comprises a plurality of message boxes for displaying one or more messages between different contacts and the user, and wherein the different contacts comprise a group or an individual.

53. The electronic device of claim 52, wherein the message boxes have a same size, a size of each corresponding message box is scaled down or scaled up based on content in the corresponding message box, or each of the message boxes displays a thumbnail of a picture.
